(19) United States
(12) Patent Application Publication
(10) Pub. No.: US 2026/0094125 A1
(43) Pub. Date: Apr. 2, 2026

(54) SYSTEMS AND METHODS FOR AUTOMATED ABSENCE REPORTING AND SCHEDULING

(71) Applicant: State Farm Mutual Automobile Insurance Company, Bloomington, IL (US)

(72) Inventor: Rob K. Williams, Peoria, IL (US)

(21) Appl. No.: 18/903,528

(22) Filed: Oct. 1, 2024

(51) Int. Cl. G06Q 10/1091; G06F 40/35; G06Q 10/0631

(52) U.S. Cl. CPC G06Q 10/1091; G06F 40/35; G06Q 10/063116

(57) ABSTRACT

A system and method for routing absence information is provided. The system and method include(s): storing, in one or more storage devices, a plurality of rules for receiving, responding to, and transmitting messages that include information relating to a user and an absence of the user; receiving a user input; comparing the user input to one or more of the plurality of rules; determining and generating a response to the user input to transmit the response to a user terminal of the user; and automatically updating an absence reporting and management system with the absence information.

### FIELD OF THE DISCLOSURE

The field of the disclosure relates generally to advanced message handling systems, and more specifically, to systems and methods for managing absences through a text message platform.

### BACKGROUND

Employers, such as large companies, that have thousands of employees may receive hundreds or even thousands of absence notifications from its employees on a daily basis. Managing these notifications for absence are time-consuming and require substantial effort even if done in an efficient manner. For example, an employee reporting their absence may leave a voicemail in their supervisor's voicemail box or in a voicemail box of an absence hotline provided by their employer. Several of these absence hotlines may be necessary to accommodate the volume of the absence notifications. Providing and monitoring these hotlines (e.g., each having a different number and respective costs to provide) can be very expensive and difficult to manage. Moreover, if the audio quality of the voicemail or the phone/service being used by the employee is poor, it may be difficult to identify the employee that is calling about the absence.

Even in the cases where the employee that is calling in to provide notice about an absence is able to be identified, known employee management software systems that are utilized by companies typically only update a schedule on a periodic basis (e.g., every fifteen minutes or more). However, in many cases real-time updating of employee work schedules is critical, and untimely updating may result in staffing issues such as staffing shortages and other negative impacts on the workforce.

With respect to a company that includes a call center for responding to customer calls, staffing shortages of employees that work in the call center may lead to decreased operating performance and impact customer wait times and employee morale. Additionally, accounting for absent employees oftentimes requires manual work, such as the manual updating of any meetings and/or calendar entries that the absent employee was included in. In many known employee management systems, it is difficult to manage such a large volume of absences and also update work schedules in view of such absences, especially in a timely manner where every minute is critical.

Accordingly, it would be desirable to have an absence reporting and management system that can efficiently and effectively handle voluminous notifications of absence, update workflow schedules, and provide absence notifications/updates to necessary parties within the company in real-time and automatically, via a streamlined interface that does not require a plurality of absence hotlines to handle the large volume of absence reports.

### BRIEF DESCRIPTION OF THE DISCLOSURE

The present embodiments relate to, inter alia, systems and methods for processing absences reported by a user (e.g., an employee or worker) via an absence reporting and management system. The system may include a backend computing system, a messaging system computing device, one or more client devices, one or more (e.g., third party) servers, one or more databases, and/or one or more connected services.

In at least one embodiment, a system for absence reporting and management is provided. The system may include one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, in one instance, the absence reporting and management (ARM) computer system may include one or more processors, one or more computer readable storage devices, and a plurality of program instructions stored on at least one of the one or more storage devices for execution by at least one of the one or more processors. When executed by the one or more processors, the plurality of program instructions cause the one or more processors to: a) store a plurality of rules including receive, response, user, and transmission rules for receiving, responding to, and transmitting messages (e.g., responses) to a user, respectively; b) receive messages from a user based on the response rules; c) compare the received messages to the plurality of receive rules; d) confirm the identify of a user based on the user rules; e) determine a proper response to the received messages based on the response rules; f) compare the transmitted messages to the plurality of transmission rules; g) transmit messages including the response to a user terminal associated with the user based on the comparisons; i) confirm the accuracy of information provided by the user via the received messages, and j) transmit (e.g., automatically) user absence information across a plurality of services operatively connected to or as part of the system. The ARM system may include additional, less, or alternate functionality, including that discussed elsewhere herein.

In another embodiment, a computer implemented method for absence reporting and management is provided. The method may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, the method may include: a) storing a plurality of rules including receive, response, user, and transmission rules for receiving, responding to, and transmitting messages (e.g., responses) to a user, respectively; b) receiving messages from a user based on the response rules; c) comparing the received messages to the plurality of receive rules; d) confirm the identify of a user based on the user rules; e) determining a proper response to the received messages based on the response rules; f) comparing the transmitted messages to the plurality of transmission rules; g) transmitting messages including the response to a user terminal associated with the user based on the comparisons; i) confirming the accuracy of information provided by the user via the received messages, and j) transmitting (e.g., automatically) user absence information across a plurality of services operatively connected to or as part of the system. The method may include additional, less, or alternate actions, including those discussed elsewhere herein.

In still another embodiment, a non-transitory computer readable medium having computer-executable instructions embodied thereon for absence reporting and management is provided. The computer-executable instructions may be implemented using one or more local or remote processors, servers, sensors, transceivers, mobile devices, wearables, smart watches, smart contact lenses, voice bots, chat bots, ChatGPT bots, augmented reality glasses, virtual reality headsets, mixed or extended reality headsets or glasses, and other electronic or electrical components, which may be in wired or wireless communication with one another. For example, when executed by at least one processor, the computer-executable instructions cause the at least one processor to: (a) store a plurality of rules including receive, response, user, and transmission rules for receiving, responding to, and transmitting messages (e.g., responses) to a user, respectively; b) receive messages from a user based on the response rules; c) compare the received messages to the plurality of receive rules; d) confirm the identify of a user based on the user rules; e) determine a proper response to the received messages based on the response rules; f) compare the transmitted messages to the plurality of transmission rules; g) transmit messages including the response to a user terminal associated with the user based on the comparisons; i) confirm the accuracy of information provided by the user via the received messages, and j) transmit (e.g., automatically) user absence information across a plurality of services operatively connected to or as part of the system. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a block diagram of an absence reporting and management system (ARM system) in accordance with at least one embodiment of the present disclosure.

FIG. 2 illustrates a block diagram for a two-way messaging process for two-way messaging using the system shown in FIG. 1.

FIG. 3 illustrates a block diagram of an alternative two-way messaging process for two-way messaging using the system shown in FIG. 1.

FIG. 4 illustrates a simplified block diagram of a chat application as shown in FIG. 3, in accordance with the present disclosure.

FIG. 5 illustrates a block diagram of an exemplary data flow, in accordance with at least one embodiment of the present disclosure.

FIG. 6 illustrates a block diagram of an exemplary messaging flow, in accordance with at least one embodiment of the present disclosure.

FIG. 7 illustrates a diagram of an exemplary interface for a user terminal, in accordance with at least one embodiment of the present disclosure.

FIG. 8 illustrates a diagram of an alternative interface for a user terminal, in accordance with at least one embodiment of the present disclosure.

FIG. 9 illustrates a diagram of an exemplary text message user interface, in accordance with at least one embodiment of the present disclosure.

FIG. 10 illustrates an additional diagram of the exemplary text message user interface shown in FIG. 9.

FIG. 11 illustrates an additional diagram of the exemplary text message user interface shown in FIG. 9.

FIG. 12 illustrates an additional diagram of the exemplary text message user interface shown in FIG. 9.

FIG. 13 illustrates an additional diagram of the exemplary text message user interface shown in FIG. 9.

FIG. 14 illustrates an additional diagram of the exemplary text message user interface shown in FIG. 9.

FIG. 15 illustrates an additional diagram of the exemplary text message user interface shown in FIG. 9.

FIG. 16 illustrates an additional diagram of the exemplary text message user interface shown in FIG. 9.

FIG. 17 illustrates an additional diagram of the exemplary text message user interface shown in FIG. 9.

FIG. 18 illustrates an additional diagram of the exemplary text message user interface shown in FIG. 9.

FIG. 19 illustrates an additional diagram of the exemplary text message user interface shown in FIG. 9.

FIG. 20 illustrates an additional diagram of the exemplary text message user interface shown in FIG. 9.

FIG. 21 illustrates a block diagram of an embodiment of a computer system or cloud server in which various components of the system shown in FIGS. 1-3 may be implemented.

FIG. 22 illustrates a block diagram of an embodiment of a computer system in which the user terminal shown in FIG. 1 may be implemented.

FIG. 23 illustrates a flow chart of an exemplary computer-implemented method implemented by the system shown in FIG. 1.

FIG. 24 illustrates a flow chart of an exemplary computer-implemented automatic update method implemented by the system shown in FIG. 1.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DISCLOSURE

The present embodiments may relate to, inter alia, systems and methods for absence reporting via an absence reporting and management system. In an exemplary embodiment, the absence reporting and management (ARM) system includes an absence management backend device connected to a text message-based absence reporting frontend device, which may be configured as a text message-based messaging system (e.g., a short message service (SMS)). In some example embodiments, the absence management backend may be executed by a computer device and/or server, and manages communications with a plurality of external users. The absence management backend transmits absence information to connected components and/or systems that propagate the absence information through various internal services including email and scheduling (e.g., workflow management) services. In some embodiments, the absence reporting frontend is implemented by a software bot such as a chatbot.

The absence reporting and management system also manages conversations, where each conversation is a series of exchanges of messages and responses to messages, which may include questions and/or prompts. In the exemplary embodiment, the messages include information about an absence of the user. This may include information necessary to identify the user, as well as absence-specific information pertaining to the duration of and/or basis for the absence. In some embodiments, identifying information may include an alias associated with the user, a line of business that the user is part of, and a time zone associated with the user. In some embodiments, absence-specific information may include whether the absence will be a full-or partial-day absence, and/or if the absence is due to illness.

### Exemplary Absence Reporting and Management System

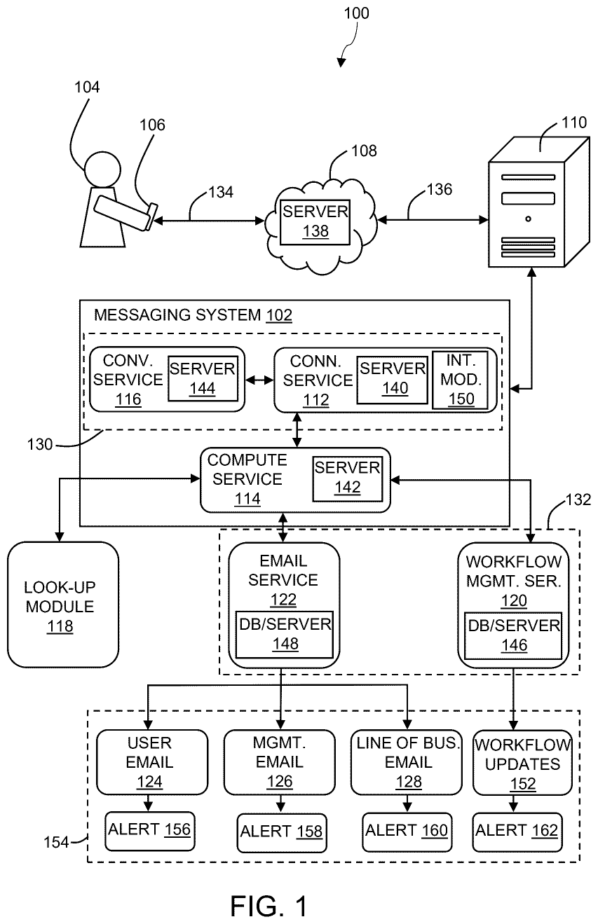

FIG. 1 illustrates a block diagram of an absence reporting and management (ARM) system 100 in accordance with at least one embodiment of the present disclosure. In the exemplary embodiment, the ARM system 100 includes a messaging system 102 that is configured to receive messages from and transmit messages (e.g., responses) to individual users 104 via respective user terminals 106 that are associated with the individual users 104 as part of an absence reporting service that is implemented and executed by messaging system 102 on user terminals 106. User terminals 106 may also be referred to as user devices. The messaging system 102 facilitates (e.g., text-based) exchanges (e.g., messages and responses) between users 104 and the messaging system 102 based on a plurality of rules and other information stored within one or more databases of or associated with the ARM system 100. The user 104 may register (e.g., opt-in) to receive messages on their user terminal 106 (e.g., user computing device such as a mobile device) from the messaging system 102 in accordance with any governing rules (e.g., FCC rules regarding data message rates that may apply, help messages, and the ability to opt-out (e.g., by texting “STOP”)). The user terminal 106 may be a computing device including a mobile device such as a mobile phone capable of sending and receiving messages, particularly text messages.

The interface of the messaging system 102 on user terminal 106 may include a text message-based messaging interface. The user 104 enters and transmits text-based information about their absence status to the messaging system 102 via such interface of user terminal 106, and the messaging system 102 receives the absence information via an input receiver software module and processes the absence information according to various rules and other parameters of ARM system 100. The absence information may include, but is not limited to, a user identifier (e.g., user name (e.g., first name, last name), an alias associated with the user, a pin associated with the user), a location (e.g., a time zone of the user), a reason for absence (e.g., sickness), a duration of absence (e.g., partial day, full-day, multi-day), and/or other information as described herein.

For example, an alias is a unique identifier associated with only one user, and each user of ARM system 100 has its own individual alias stored with ARM system 100. In some embodiments, the ARM system 100 is implemented by a company that uses ARM system 100 as a means for employees of the company to communicate their absences to the company, where users 104 are employees of the company. The company may be referred to as an absence system provider entity. The employees utilize the messaging system 102 as implemented on user terminal(s) 106 to contact the company via user terminal 106 to report their absence to the company via the absence reporting service provided by messaging system 102, and the company requests information from their employees regarding their identity and additional information regarding the absence through a series of exchanges. Once the absence of any one employee is confirmed, the company can dynamically and automatically adjust daily schedules in real-time based on absence information logged by the ARM system 100 for each employee that reports an absence using ARM system 100, via a single (e.g., toll-free) number used to provide the text-messaging aspects of the absence reporting service. At any given time, there may be multiple employees 104 in communication with the messaging system 102 via respective user terminals 106, at different points of the day or even simultaneous.

In the exemplary embodiment, the ARM system 100 includes a platform 108 that performs a variety of functions in connection with the handling of (e.g., text) messages between parties. The platform 108 is operatively connected to a main computing system 110 of ARM system 100. For example, the platform 108 may function in whole or in part as a short message service center (SMSC) and is operatively connected (e.g., via one or more networks) with messaging system 102 and the absence reporting service as implemented on user terminal 106 of the user 104. Platform 108 receives the user's inputs entered into the absence reporting service (e.g., into messaging system 102) for feeding such inputs into main computing system 110 for further processing. Main computing system 110 may be referred to as a backend computing system 110, and includes components such as hardware, storage, software, and databases used to manage critical computing functions of the company, and is configured to collect and process information from users and other data sources to carry out business operations. The backend computing system 110 may be configured to interface with and/or implement thereon services such as web (e.g., cloud-based) services that provide additional functionality for building and managing various backend or other systems, such as contact center functions (e.g., customer-facing or internal). For example, platform 108 may process a text message entered into the interface of the absence reporting service and send the processed text message to backend computing system 110.

In the exemplary embodiment, the messaging system 102 includes a connection service 112, a compute service 114, and a conversation service 116 that function as an integral part of the absence reporting service. The backend computing system 110 may be configured to interface with the various services 112, 114, 116. For example, backend computing system 110 may send the processed text message received from platform 108 to connection service 112 for further processing, which may include processing by services 114 and/or 116.

In the exemplary embodiment, the providing/transferring/sharing of data and other information between the various services and (e.g., sub-) systems of ARM system 100 may be realized by a plurality of software functions, also known as lambdas (used interchangeably herein).

The connection service 112 may be configured to function as a central connection service between platform 108, compute service 114, conversation service 116, and other services. For example, connection service 112 may be configured as an omnichannel cloud contact center service tailored to handle information from users 104 pertaining to absences. The compute service 114 may be cloud-based software that runs code in response to events and automatically manages compute resources, and may further be configured as a serverless computer service that allows for execution of functions without managing servers (e.g., to be used for event-driven backend tasks such as data processing and stream processing, and for preprocessing data before ingestion by a corresponding (e.g., machine learning) model, described herein in greater detail). The conversation service 116 may be a fully managed service for building conversational interfaces into any application, such as the absence reporting service described herein. Conversation service 116 may be utilized to create chatbots, digital assistants, machine learning-powered interactive response systems, or virtual agents.

The compute service 114 may also refer to a registry via a look-up module 118 of ARM system 100 which functions to retrieve data such as certain user data. For example, when the user is an employee of a company, the user data includes employee data such name, address, pin numbers, and/or aliases associated with the employee. In some embodiments, the look-up module 118 may be configured as a general look-up tool, capable of performing data look-ups in a variety of data tables or as otherwise provided in a database. In other embodiments, look-up module 118 may be configured as a dedicated alias data look-up module, where the alias data is associated with a user in an alias registry. Such an alias may be in the form of a code or other unique identifier linked to or otherwise associated with the employee within a company's records, for example for identifying the employee other than by name. Look-up module 118 may be configured to utilize indexing and data structures to speed up data retrieval. A function (e.g., lambda) may be used to retrieve data from the alias registry.

In some embodiments, the compute service 114 may also be configured to execute code in response to triggers such as changes in data, shifts in system state, or actions by users, and may be configured to be triggered by data stream services and can connect to storage systems or into workflows (e.g., with step functions), allowing for building of a variety of real-time serverless data processing systems and/or applications. For example, data stream services may be configured to ingest real-time data, such as application logs and telemetry data, for machine learning (ML), analytics, and other applications, and the storage systems may include either or both of relational databases (e.g., SQL database services) and non-relational databases (e.g., NoSQL database services), and other object storage. NoSQL databases may be in the form of a fully managed cloud database that supports both document and key-value store models.

Once a conversation between the user 104 and the absence reporting service of messaging system 102 concludes with all inputted absence information having been verified/confirmed as accurate, the details of the absence are propagated through the company's system, which may include a workflow management service 120 and an email service 122. Workflow management service 120 may also be referred to as a scheduling service. Email service 122 may also be referred to as a communication service. The compute service 114 may be operatively connected with the workforce management service 120, which may be configured to provide scheduling services for the workforce of a company.

For example, the workforce management service 120 may perform a variety of workforce availability, productivity, and scheduling-related functions, including assisting with optimizing staffing levels, improving (e.g., internal) customer service, and enhancing efficiency, in particular in the context of contact center workflow. This may also include performing forecasting, scheduling, and adherence tracking to align resources with specific production activities based on deadlines, work arrivals, and work volume. Availability and schedule changes can be updated on-the-fly to better manage over-and under-staffing, permit shift-swapping, and/or provide for other coverage to optimize staffing. For example, compute service 114 may be configured to generate absence data representative of the absence information obtained via a conversation between user 104 and conversation service 116 in a file format compatible with workflow management service 120, so that the absence data can be implemented into workflow management service 120.

Workflow management service 120 may be configured to output a variety of visuals pertaining to workforce availability/scheduling data, including chart, graphs, and/or calendars showing shift assignments, unavailability events, working shift events, non-working shift events, calendar events, and time off events. These can be published or otherwise made available within workflow management service 120 so that other company personnel can view such workforce availability/scheduling data when using workflow management service 120. Compute service 114 may be integrated with workforce management service 120 to cause the creation and/or updating of workforce availability/scheduling data in connection with absences reported via the ARM system 100. For example, each of compute service 114 and workflow management service 120 include any necessary code, APIs, plugins, and/or any other software necessary for the two services to be integrated with one another to achieve seamless integration. This may include one or more lambdas that transfer data packets such as JSON packets to/from workflow management service 120 so that information reflective of employee absences can be propagated through workforce schedules via workflow management service 120.

Email service 122 may be an email service used by the company (e.g., for conducting company business via email), such as an enterprise email service for business. The compute service 114 may also be configured to interface with the email service 122 to propagate certain aspects of the absence information obtained and processed by services 112, 114, 116 through email service 122, similar to the operative relationship between compute service 114 and workflow management service 120. For example, compute service 114 may be configured to process absence data representative of the absence information obtained from user 104 into a file format compatible with email service 122, so that the absence data can be implemented into email service 122. More specifically, the absence data may be transmitted from compute service 114 to email service 122 in a format that enables distribution of the absence data within email service 122, specifically to (i) the user's email 124 (e.g., employee email 124), (ii) management email 126, and/or (iii) line of business email 128. This may include implementing a lambda that outputs data into PST and PST formats.

Regarding user email 124, distribution of the absence information via email service 122 may include sending an email to the employee's email account, and/or automatically adding a new calendar entry via a calendar function of email service 122 to the employee's email account, where the calendar entry matches the date/time which the employee will be absent. This would enable others within the company to be able to see the employee's unavailability within the email service 122, where such unavailability corresponds to the absence, and may be visible to others within the company in the form of a blocked off section that appears on the employee's calendar as provided in email service 122.

Regarding management email 126, distribution of the absence information via email service 122 may include sending an email to management personnel associated with user 104 via email service 122, and/or automatically modifying any meetings that the employee was scheduled to attend, for example to remove the absent employee from the meeting attendee list, or a proposed rescheduled date/time to a date/time that the absent employee is available. Management personnel may include a (e.g., direct) supervisor of the employee and/or a higher level manager, for example. Regarding line of business email 128, distribution of the absence information via email service 122 may include automatically sending an email regarding the absence to a line of business email mailbox, and/or modifying a global calendar of one or more line of businesses (e.g., business units) within the company to which the user 104 belongs, so that the entire business unit(s) is/are apprised of the absence.

Such automated emails may be programmed via email service 122 to have a certain subject line (e.g., ABSENT-DATE-EMPLOYEE NAME) to convey the absence information in a standardized format. Email service 122 may also be configured to send automated emails to other company personnel such as a human resources (HR) team member of the company, for example for recording the absence for in HR-specific records and/or for other record-keeping purposes. Compute service 114 may be integrated with email service 122 to cause the creation and/or updating of emails and/or calendar events in connection with absences reported via the ARM system 100. For example, each of compute service 114 and email service 122 include any necessary code, APIs, plugins, and/or any other software necessary for the two services to be integrated with one another to achieve seamless integration. This may also include, for example, pushing updates through email service 122 that remove the absent employee from meetings the employee was scheduled to attend, and/or sending an automatic email to appropriate internal (or even external) parties containing the employee's name and the particular absence date/time for the employee as described herein.

Connection service 112 and conversation service 116 may collectively be referred to as a dialog module 130. For example, dialog module 130 sends messages back and forth to user 104 until all necessary absence information is obtained. Workforce management service 120 and email service 122 may collectively be referred to as a workflow module 132, and the scheduling and email information propagated or otherwise contained therein maybe referred to as workflow information. For example, workflow information of the scheduling service (e.g., workflow management service 120) may include work shift and scheduling information of individual employees which may be in the form of a calendar, and any other workforce or company information including or relating to work volumes, work shifts, work schedules, work availability/unavailability, shift swapping, meetings, events, deadlines, overtime, arrival/departure times, holidays, and other closures, and any other scheduling aspects described herein. Workflow information of the communication service (e.g., email service 122) may include emails generated by and sent from email service 122 to the user 104 (e.g., the employee), a first line leader at the company, and an email mailbox for the specific line of business the user 104 is part of or any other entities described herein, as well as calendar invites of employees for meetings, and any other aspects of availability/unavailability that can be indicated via functions of email service 122 (e.g., communication service).

In the exemplary embodiment, communication between user terminal 106 and the platform 108 is by way of communication channel 134, which may be part of a cellular network, for example via the cellular service provider that provides cellular data/service to the user terminal 106. In other embodiments, the communication channel 134 is part of an internet-connected network, for example the Internet as provided by an internet service provider (ISP) and to which the user terminal 106 is connected to. This may include a local-or-wide-area network (LAN or WAN, respectively). The platform 108 is operatively connected to the backend computing system 110 via communication channel 136, which in the exemplary embodiment is the Internet as provided by one or more ISPs, for example ISPs that provide internet service to the provider of platform 108 and/or the ISP of the entity (e.g., company) that owns backend computing system 110. The communication channels 134 and 136 provide for two-way communication and information exchange between the user terminal 106 and the messaging system 102 via platform 108 and backend computing system 110 within ARM system 100. For example, communication channel 136 may be configured to transfer data packets such as a JSON packets to/from platform 108 from messaging system 102.

In the exemplary embodiment, plurality of components of ARM system 100 may include or otherwise be operatively connected to a server, as needed. Platform 108 may include a server 138, connection service 112 may include a server 140, compute service 114 may include a server 142, conversation service 116 may include a server 144, workflow management service 120 may include a database/server 146, and email service 122 may include a database/server 148. Alternatively, services including but not limited to compute service 114 may be serverless on the company's end, and as such server 142 may refer to a server on an end of the provider (e.g., cloud provider) of compute service 114. Any database or server described herein may be configured as a combined database/server or separate database and server components.

In the exemplary embodiment, connection service 112 may be integrated with workflow management service 120 and email service 122 via an integration module 150, which may be configured as one or more dedicated software components within or associated with connection service 112 or within or associated with computer service or workflow management service 120 and/or email service 122. For example, integration module 150 may include (i) a secure, managed workflow management integration software component with support for commercially available desktop and mobile workflow management applications such as workflow management service 120, and (ii) a secure, managed business email and calendar integration software component with support for commercially available desktop and mobile email client applications such as email service 122.

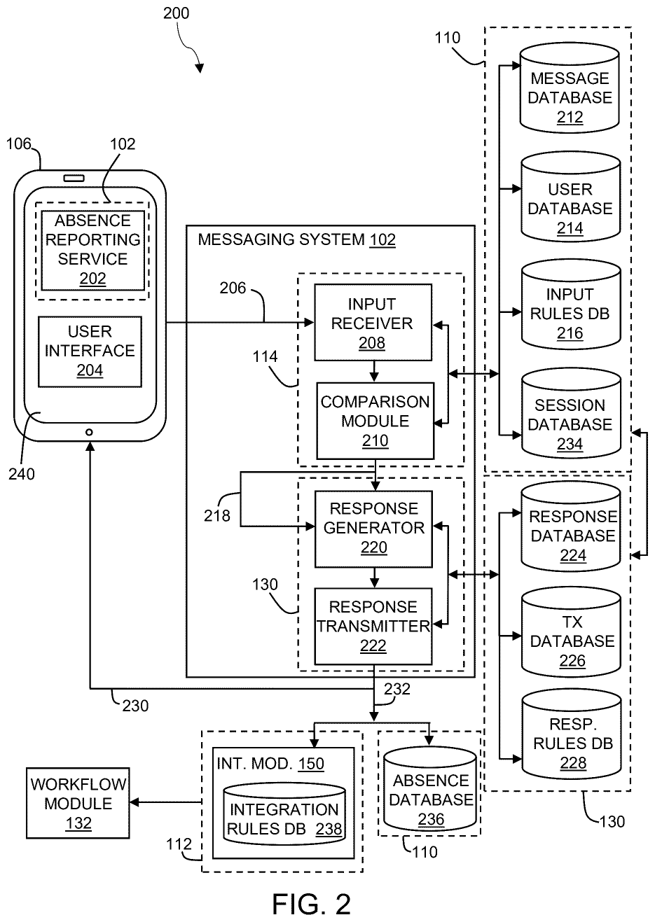

Integration module 150 is configured to provide for seamless integration with workflow management service 120 and email service 122. For example, such integration with email service 122 provides for the ability to seamlessly access email, contacts, and calendars using a desired client application, including any client application supporting the IMAP protocol, or directly through a web browser. Moreover, integration module 150 may be integrated with corporate directories, use email storage (e.g., email journaling) to meet (e.g., regulatory) compliance requirements, and control data encryption keys and a location in which data is stored, such as data relating to email service 122. Integration module 150 may further have interoperability with one or more databases/servers (e.g., server 140, database/server 146, database/server 148), and programmatically manage users, groups, and resources using a software development kit (SDK) associated with connection service 112, for example. In some embodiments, integration module 150 may be one or more standalone software components integrated within any sub-system or service within ARM system 100, including within platform 108, backend computing system 110, compute service 114, workflow management service 120, email service 122, and/or any other applicable component/service of ARM system 100, for example. Integration module 150 may operate according to a set of integration rules stored within an integration rules database (shown in FIG. 2) for integrating the acquired absence data into file formats and/or other usable code so that the workflow management service 120 and email service 122 may each be updated with the absence information.

Integration module 150 is used in conjunction with automatically updating the company's systems with the latest employee absence information acquired by way of user(s) 104 using user terminal(s) 106 to report their absence via messaging system 102. For example, once an absence of one or more users 104 is/are verified, integration module 150, in association with other components of ARM system 100 such as compute service 114, may be configured to push updated real-time absence information to workflow management service 120 and email service 122 so that the absence information is automatically propagated through ARM system 100, informing relevant parties of the absence(s) via emails 124, 126, 128 and workflow updates 152 that are output from workflow module 132. For example, workflow updates 152 may include various scheduling, calendaring, and/or other updates of items managed by workflow management service 120. Emails 124, 126, 128 and workflow updates 152 may be collectively referred to as automatic updates 154.

The automatic updates 154 may include absence information that has been converted by integration module 150 to one or more file formats compatible with and usable by workflow management service 120 and email service 122, so that the information contained within automatic updates 154 can be used and displayed by workflow management service 120 and email service 122. Without limitation, file formats for workflow management service 120 may include JSON, and file formats such as CSV, PST, and OST may be utilized in connection with email service 122, for example. For example, any plurality of functions (e.g., lambdas) may be used within ARM system 100 for data operations between platform 108, backend computing system 100, connection service 112, compute service 114, conversation service 116, workflow management service 120, and email service 122, including but not limited to data exchange, data conversion, and any other data manipulations necessary for ARM system 100 to operate properly. These outputs from integration module 150 may be categorized as (i) scheduling integration parameters, where such scheduling integration parameters are used to update workflow management service 120 with the absence data, and (ii) email integration parameters, where such email integration parameters are used to update email service 122 with the absence data. Accordingly, the absence information propagated through services 120 and 122 may implement a variety of scheduling and email integration parameters configured to provide automatic scheduling and email updates to applicable parties within the company via the respective services 120 and 122. Services 120 and 122 may be collectively referred to as absence reporting services. The scheduling integration parameters and email integration parameters may collectively be referred to as user absence parameters.

Automatic updates 154 may also include a function that issues a plurality of alerts. Alternatively, these alerts could be alert features native to workflow management service 120 and/or email service 122. Alert 156 may be sent in connection with user (e.g., employee) email 124. Alert 158 may be sent in connection with management email 126. Alert 160 may be sent in connection with line of business email 128. Alert 162 may be sent in connection with workflow updates 152. For example, a manager of the user (e.g., employee) may also have installed on their work computing terminal the workflow management service 120 and the email service 122. Once automatic updates 154 are distributed to workflow management service 120 and the email service 122, other personnel such as a manager may, on their work computing terminal, view an updated employee schedule as (e.g., automatically) generated by workflow management service 120, may receive an email such as management email 126 providing notice of the absence via the email service 122, and may receive other updates such as calendar and/or scheduling updates that may be implemented on one or both of workflow management service 120 and the email service 122.

This may include updating an existing calendar invite in view of the incorporated absence information (e.g., a change in the time or the participants of a meeting). The manager may receive one or more of alerts 158 and 162 or other indicators on a work computing device associated with the manager, the alerts 158 and 162 alerting the manager that services 120 and 122 contain new information. Such alerts may be audible (e.g., a chime played through a speaker of the manager's work computing device), visible (e.g., a GUI badge/icon on a screen of the manager's work computing device), and/or tactile (e.g., vibration representative of an alert on the manager's work computing device). Automatic updates 154 may include deleting the absent employee from scheduled meetings, updating meeting times based on the time the employee will be absent (e.g., in the case of a partial day absence), and other similar scheduling adjustments. For example, such scheduling adjustments may include automatic proposal of alternative meeting times to the meeting participants based on the absence information. In some embodiments, communications within ARM system 100 pertaining to updating services 120 and 122 with user absence information may be made between connection service 112 and services such as workflow management service 120, which may be performed by an API call executed by compute service 114.

In the exemplary embodiment, the platform 108 may be an automation platform 108 configured as cloud-based infrastructure that performs a variety of functions, including functioning as an SMSC. The automation platform 108 may be configured with a variety of application programming interfaces (API's), decision logic, and microservices. The API's may include, for example, HTTP REST-based API, the SMS-based SMPP protocol, MM4, and MM7 protocols for multimedia, for handling SMS and MMS messages. The APIs, decision logic, and microservices may provide programmatic certainty. The automation platform 108 may include enterprise-grade infrastructure and redundancy at every level of the stack, and may provide for embedding omnichannel communications into customer relationship management (CRM), control implementation summary (CIS), customer experience (CX), and existing systems using the API's.

The automation platform 108 may include high reliability (e.g., 99.999% (e.g., five-nines) reliability) delivered through (e.g., active-active) architecture within data centers (e.g., geographically disparate SSAE-18 data centers), provide for direct carrier connections with multi-point connectivity providing proof-of-delivery across all channels, and include aggregator status combined with low-latency, high-throughput (e.g., fiber) backbone such that communications are delivered in seconds. The automation platform 108 may include audited, enterprise-grade security providing, for example, SSAE-18 SOC 2 Type 2 certifications, PCI certifications, as well as HIPAA compliance. In other embodiments, other components of messaging system 102 may perform some of the above-described functions of the platform 108. For example, the compute service 114 may perform such functions in combination with or separate from the automation platform 108.

In the exemplary embodiment, the messaging system 102 of the ARM system 100 may be configured to receive information from a user 104 about the user's absence and communicate with the user 104 to obtain additional information about the absence via a user interface (shown in FIG. 2) of a user terminal 106. The messaging system 102 may include computing infrastructure such as on-premises computing devices, servers, and storage that can include dedicated software installed thereon, and/or computing infrastructure and services that is/are part of a networked (e.g., cloud) computing system configured and/or provided as: (i) Infrastructure as a Service, or IaaS, which delivers on-demand infrastructure resources to organizations via the cloud, such as compute, storage, networking, and virtualization, (ii) Containers as a Service, or CaaS, which delivers and manages all the hardware and software resources to develop and deploy applications using containers, (iii) Platform as a Service, or PaaS, which delivers and manages all the hardware and software resources to develop applications through the cloud, and (iv) Software as a Service, or SaaS, which provides the entire application stack, delivering an entire cloud-based application that customers can access and use (e.g., where SaaS applications may be accessed directly through a web browser). Components of the computing infrastructure may be configured to be operatively connected to outside systems, such as systems of mobile phone carriers or related entities in connection with the receiving/sending of text messages between the messaging system 102 and the user terminal(s) 106 via communication channels 134 and 136 and similar communication channels associated with communications between backend computing system 110 and services 112, 114, 116, 120, and 122.

Further regarding the various functions (e.g., lambdas), messaging system 102 may call a lambda relating to aspects of platform 108, where such lambda then executes an API enabling interfacing of messaging system 102 with platform 108. Another lambda may be configured to transfer a data packet to workflow management service 120 which then updates schedules according to the data received in the data packet, including any necessary data conversions that need to take place for the absence data that was extracted from the information provided by user 104 to be usable by workflow management service 120. Yet another lambda may include a lambda designed for connection service 112 to interface with email service 122 to send out emails reflecting the absence data, and any necessary data conversions to accomplish such. These are just a few examples of lambdas, and many more are described herein in connection with other aspects of the absence reporting process realized by ARM system 100.

The ARM system 100 and the processes described herein represent an improvement over conventional voice line (e.g., hotline) absence reporting systems by way of reducing the costs associated with obtaining and processing voluminous absences, reducing the time it takes to push updated information throughout company systems, and causing automatic and real-time updating of systems with absence information. For example, where prior known systems may take up to 15 minutes or more to process work schedule updates on a limited basis, the exemplary ARM system 100 described herein automatically updates work schedules in real-time, eliminating the need for manual intervention and reducing errors. Additionally, where prior systems may require a company to pay operational costs for hosting several absence hotlines, the exemplary ARM system 100 can operate with a single (e.g., toll-free) number used as part of the text message-based interface and processes described herein. Improvements in organizational agility and flexibility are also realized, including, for example more flexible scheduling (e.g., swapping shifts, overtime).

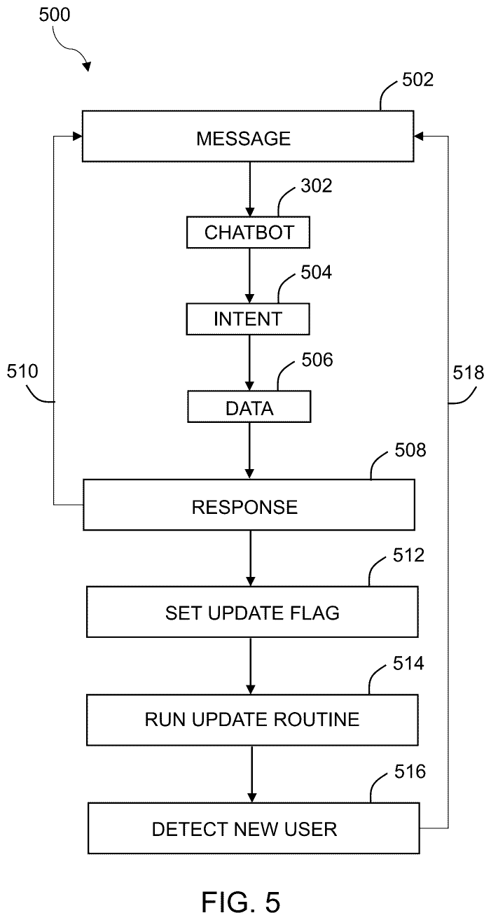

Additionally, or alternatively, ARM system 100 may be configured to process an audio (e.g., voice) message into a text string that is then processed in the manner described herein. For example, input 206 may be a voice message left by an employee on a company voicemail system, and input receiver 208 may be programmed to receive audio data from the voice message to determine words in the voice message. A database similar to those shown in FIG. 2 may be used to store data relating to an audio-to-text conversion, and such a database may store both the audio data extracted from the voice message, as well as other data used by a module such as comparison module 210 for comparing words parsed from the audio data to a collection of known words for determining an intent or meaning of the voice message. For example, such a database may include a table of known words related to the topic of absence reporting that can be used as a look-up for the parsing of the words extracted from the voice message and determining a meaning thereof. Moreover, a chatbot (such as chatbot 302, described later in connection with FIG. 5) may be programmed to handle such audio-to-text conversion tasks and/or to assist the other modules in translating or otherwise processing the audio data from the voice message into text and/or to determine an intent of the words extracted from the audio data. The text resulting from such audio-to-text conversions may then be used in the manner described herein for absence reporting and scheduling.

### Exemplary Two-Way Message Handling

FIG. 2 illustrates a block diagram of components used to perform a two-way message handling process 200. In the exemplary embodiment, the two-way message handling process 200 is performed by the messaging system 102 (shown in FIG. 1).

In the exemplary embodiment, a user 104 uses their user terminal 106 to operate an absence reporting service 202 (also referred to as an absence reporting program) on their user terminal 106 via a user interface 204 of the user terminal 106, where the absence reporting service 202 is implemented by the messaging system 102. The user 104 interacts with user interface 204 of user terminal 106 to engage and interact with the absence reporting service 202. The input of user 104 may include text in the form of a text message including certain text-based prompts or other entries such as keywords or other (e.g., user-specific) information that is entered by the user 104. This text is received and processed by the messaging system 102 and parsed to extract absence data that is usable to propagate the absence through ARM system 100. The user input (e.g., text) entered by the user 104 via the user interface 204 is routed as an input 206 to an input receiver 208 of the messaging system 102. Input receiver 208 parses the input 206, which may include parsing both the text content of the message as well as underlying information of and/or relating to the input 206 such as the date/time the input 206 was received by input receiver 208 and other information such as a device ID of the device (e.g., user terminal 106) that the input 206 was received from, or any other pertinent metadata.

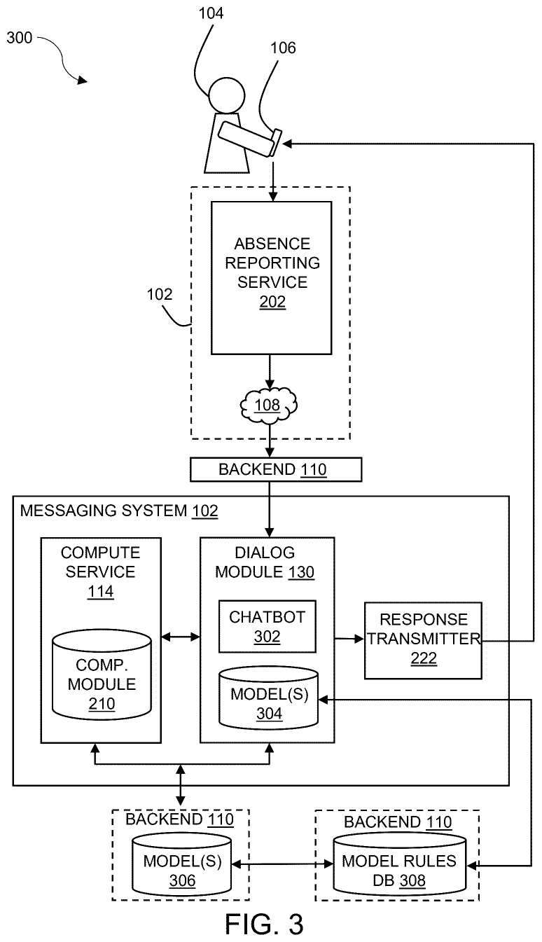

For example, parsing input 206 may include (i) message retrieval, including receiving the user's message, which could be plain text or include formatting (e.g., bold, italic, etc.), (ii) tokenization, including the message being split into individual tokens (words or phrases), which helps break down the text for further analysis, (iii) entity recognition, which identifies entities within the message, where entities may include specific pieces of information such as dates, locations, or names, (iv) stylized text parsing, including if the message contains stylized text (e.g., markdown, HTML), and extraction of the actual content, which may include determining how text is formatted, and (v) data extraction, including extracting relevant information if the message contains specific data (e.g., extracting a date). If a software bot such as a chatbot (shown in FIG. 3) is implemented and used as part of the absence reporting service 202, parsing may further include (vi) intent recognition, including determining the user's intent based on the message, which includes understanding what action the user wants to perform (e.g., asking a question, making a request, etc.), (vii) context handling, including maintaining context from previous interactions to provide relevant responses, which considers the conversation history and any relevant context when interpreting the current message, and (viii) natural language understanding, including techniques for analyzing the message to extract meaning, which includes understanding synonyms, homonyms, and context-specific language. Platform 108 may be used in conjunction with input receiver 208 to realize the above-described functions, including any necessary lambdas for operational data flow between input receiver 208 and platform 108.

Once input 206 is processed by the input receiver 208, a comparison module 210 may be used to compare the data from input 206 to data stored in one or more databases as part of the messaging system 102 preparing a response to the message represented by input 206. For example, once any data from input 206 has been stored and/or cross-referenced to message database 212, the content of the input 206 may be analyzed by comparison module 210. This may include comparing information from input 206 to information stored in a user database 214 to determine if information contained in input 206 matches information on file for a user 104. This may include comparing first and last names, user ID's (e.g., aliases, pins), user location (e.g., time zone), and other user-specific data. The functions performed by input receiver 208 and comparison module 210 may be performed in conjunction with an input rules database 216 that includes therein a set of rules for extracting information from the input 206 and comparing the information in input 206 to information that is already of record within ARM system 100, and a set of (e.g., matching) rules for determining if data extracted from input 206 matches data stored in ARM system 100.

For example, input rules database 216 may include an extraction rule that defines how a device ID of the device that input 206 was received from is extracted from input 206 and stored in message database 212, and/or a comparison rule that defines how a user ID (such as an alias) which may be stored in user database 214 is analyzed when a user 104 enters the user ID as part of the absence reporting process. If the result of the analysis by comparison module 210 is a match being determined, then the process of responding to input 206 proceeds to a next step, otherwise a communication 218 is sent to user terminal 106 of user 104 indicating that the provided information was not a match and asking for entry of new information. For example, if no match is found for the provided user alias, communication 218 such as a flag may prompt a response to be formulated that asks user 104 for re-entry of the alias, and then the matching process is repeated on the newly entered information.

If the comparison module 210 determines a match, the output from comparison module 210 is passed to response generator 220 and response transmitter 222 to continue the response process. The output from comparison module 210 may include information regarding input 206 as determined by both input receiver 208 and comparison module 210. The response generator 220 may refer to a response database 224 when generating a message in response to input 206. The response database 224 may have stored therein a response script. For example, the response script may be in the form of a call-center script that includes a defined decision tree, provides certain scripted answers in response to certain inputs, and/or that performs certain look-ups in response to certain inputs. In other embodiments, response generator 220 (and response database 224) may include or operate in conjunction with a chatbot such as an artificial intelligence (AI)-based chatbot, described below in more detail, in which case response generator 220 may be configured to analyze keywords, intent, and context of the message of input 206. Rules defining transmission of a response to input 206 may be stored in a transmission (“TX”) database 226. The functions performed by response generator 220 and response transmitter 222 may be performed in conjunction with a response rules database 228 that includes therein a set of rules for generating a response to the input 206 and transmitting the response to input 206 to user terminal 106 of user 104.

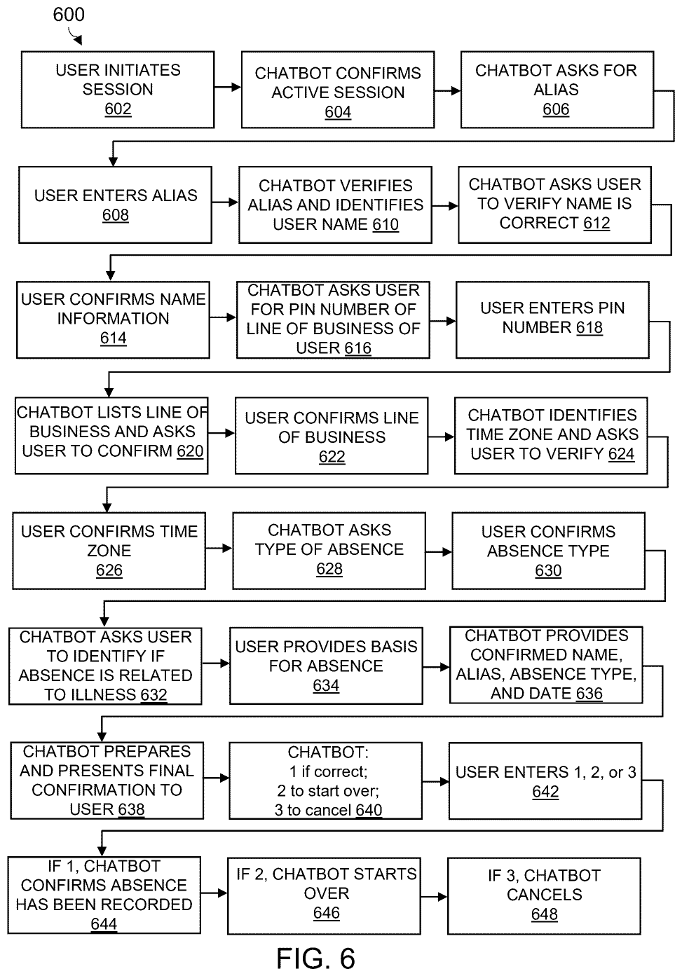

The response rules database 228 may include a response rule that defines how a response by response generator 220 to an input 206 that provides alias information is provided. For example, the response generator 220 may reference information stored in user database 214 as well as response database 224 to provide, as a response, a first and last name associated with the alias. Response transmitter 222 may interface with transmission database 226 and/or response rules database 228 in connection with a timing rule that defines when a response is transmitted (e.g., by defining timing parameters for response transmission). For example, to provide a timely response, response transmitter 222 may reference one or both of transmission database 226 (which may store transmission information such as timing information) and response rules database 228, for transmission of a response 230 to user terminal 106 of user 104. The processes associated with generating, sending, and processing input 206 and generating and transmitting response 230 may be repeated over and over until all of the various information (shown in FIG. 6) required to confirm an absence is acquired and verified. In this regard, transmission database 226 may also store information concerning whether/when to transmit information to workflow module 132. Backend computing system 110 may also include a session database 234 that stores additional aspects of an absence reporting (e.g., messaging) session of user 104 and messaging system 102. These session aspects may include total session time or other parameters of the session.

Once the messaging session has concluded and the absence information has been confirmed as accurate, the response transmitter 222 may refer to transmission database 226 to transmit confirmed absence information as output 232 to systems and modules including an absence database 236 and workflow module 132, so that the absence information may be recorded in absence database 236 and also distributed to services 120 and 122 to provide real-time updating and/or notice of employee availability, scheduling, and appointments/meetings. For example, absence database 236 may serve as central repository for the storing of cumulative absence information for a plurality of users 104. Additionally, look-up module 118 may be configured to facilitate a look-up in a database such as user database 214, absence database 236, or any other applicable database of or associated with ARM system 100 in order to pull information relevant to any particular user 104 as part of the absence reporting process. If no match is found for the provided user alias (as indicated by communication 218 (e.g., a flag)), for example, response 230 may instead ask for re-entry of the alias, and then the matching process is repeated on the newly entered information.

In some embodiments, the integration of the absence data into workflow management service 120 and email service 122 may be accomplished by integration module 150 processing the acquired and confirmed absence information according to various rules within integration rules database 238. For example, integration rules database 238 may include respective rules for each of workflow management service 120 and email service 122. These rules may define how the absence information is packaged for use within workflow management service 120 and email service 122, so that other employees (e.g., managers, supervisors) can see the latest employee availability information and scheduling information in each of workflow management service 120 and email service 122. Integration module 150 may also be configured to issue automatic updates 154 including alerts 156, 158, 160, and 162. Integration module 150 may determine automatic updates 154 including alerts 156, 158, 160, and 162 based on corresponding rules within integration rules database 238. This may include running a script, such as a script that is automatically triggered to run upon confirmation of the absence information.

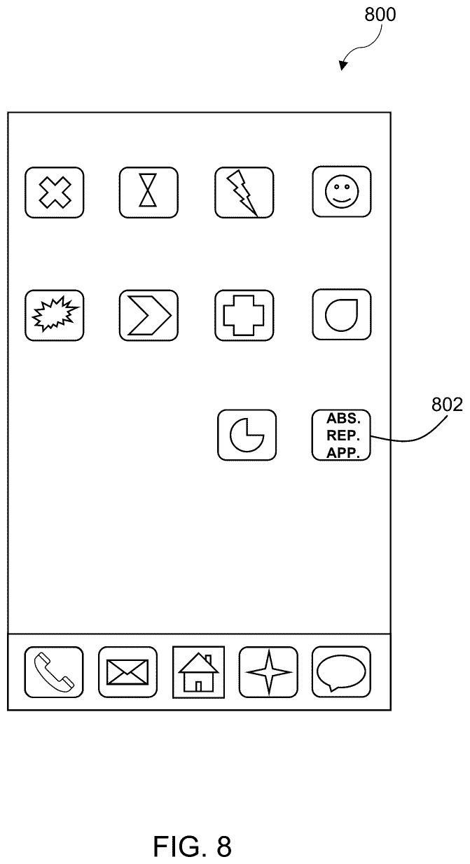

In some embodiments, the input receiver 208 and the comparison module 210 may be implemented by/in other aspects of the ARM system 100, such as the backend computing system 110, and platform 108 may be integrated in messaging system 102. In one embodiment, the user interface 204 may include a text messaging interface provided by the operating system (OS) of the user terminal 106, such as the stock text messaging interface of the OS. In other embodiments, the user interface 204 may include an interface of a dedicated application (shown in FIG. 8) that provides the absence reporting service, where the application is downloadable or otherwise installable on the user terminal 106. The messaging system 102 may include a 5 or 6 digit short code (e.g., an SMS short code) which the user 104 may enter as the recipient of the user's message, for example during a first usage of the absence reporting service 202. In some embodiments, information stored in the various databases 212 etc. may be used for other purposes such as other forms of verification, data logging, and training of models (shown in FIG. 3).

Each of input receiver 208, comparison module 210, response generator 220, and response transmitter 222 may be configured as software modules within messaging system 102 or within systems/services (e.g., services 112, 116) that are part of messaging system 102. Message database 212, user database 214, input rules database 216, and absence database 236 may be part of backend computing system 110. Response generator 220, response transmitter 222, response database 224, transmission database 226, and response rules database 228 may be part of dialog module 130, however, this is for example purposes only, and the various databases may be located within any applicable components of ARM system 100. The various modules and/or services may each be configured as an API (application programming interface) or configured as code other than an API. The response(s) 230 are presented via absence reporting service 202 as executed on user terminal 106 via a display 240 of user terminal 106, so that user 104 may view and/or respond to response 230 as part of the absence reporting process, where display 240 be a screen such as an LED screen.

The processes described herein and implemented by ARM system 100 help to eliminate issues in conventional absence reporting systems where employees attempt to report an absence, but a significant failure of the system leads to disciplinary action on employees because the absence was not properly reported. Automating processes and eliminating manual intervention is a way to avoid staffing shortages, misidentified absence call-ins, and reduce costs for the company. By automating the absence process using text messaging as described herein, workflow information can be updated in real-time, and real-world benefits such as staffing shortages can be avoided or better mitigated. For example, since employees will be typing in their alias for identification, the likelihood of an employee not being properly identified is significantly reduced. In the context of a company that includes a contact center (e.g., call center) as part of their business, understaffing issues may lead to decreased moral of other employees (e.g., amongst contact center employees) who may hear of these issues and/or have to adjust their own schedules (e.g., pick up an extra shift or work overtime). Moreover, without additional staffing, customers using the call center face longer wait time periods before their call is answered.

In the exemplary embodiment where the user 104 is a company employee and the ARM system 100 is managed by the company, the user information stored in the user database 214 may include name, alias/alias code, location, and other information associated with the user 104 within a set of records of the company (e.g., internal records of the company). A response to the user input 206 is determined by a plurality of comparisons made by comparison module 210. The comparison module 210 performs analysis on the input 206, such as comparing input 206 to information present within the company's systems, for example as stored in various databases within and/or associated with the backend computing system 110. This information may include including user information such as employee information, including the name of the user, the time zone of the user, the line of business of the user, and internal user identifiers such as an employee number and/or other codes/pins/passwords associated with the employee, which may be stored in a user database 214 of the company. The analysis and comparison of input 206 to the information in user database 214 can be performed according to a set of rules stored in a message database 212.

The exemplary embodiment includes a fully automated system where the employee begins the absence reporting process by texting a start word such as “Hi” to a toll-free number associated with the ARM system 100. The text message is processed by the platform 108 and sent to the backend computing system 110 of the employee's company, which may be part of cloud-based infrastructure of the company, which may be hosted/provided by a cloud services company. That processed message is then sent to the connection service 112 and is further processed. The connection service 112 will send messages back and forth with the employee until the conversation is complete. Information collected from the employee includes the absence type (all day, late arrival), reason for absence (illness, other), date of absence (today, tomorrow) and time of arrival if needed. Once the required information is obtained from and verified by the employee, email confirmations are sent via email service 122 to the employee and other personnel such as a first line leader and an email mailbox for the specific line of business the employee works in. Next, an update to the workflow management service 120 is made based on the absence data derived from the employee's absence information to update scheduling involving the absent employee. This may include shifting a separate employee's schedule to cover for the absent employee, and other such scheduling maneuvers.

### Additional Exemplary Two-Way Message Handling

FIG. 3 illustrates a simplified block diagram of an alternative two-way message handling process 300. In the exemplary embodiment, process 300 is performed by the messaging system 102 (shown in FIG. 1). The components and process steps of process 300 are largely similar to or the same as those in process 200, except that the components and steps of process 300 include implementations of AI and/or machine learning (ML) that may be configured as part of messaging system 102 and/or backend computing system 110.

In the exemplary embodiment, dialog module 130 may be configured to include a chatbot 302 and one or more associated algorithms, for example used as part of one or more models 304 associated with chatbot 302, that is/are utilized to conduct the conversation with user 104 as part of the absence reporting process. Model(s) 304 may include one or more models such natural language models, machine learning models, and any variants thereof. The implementation of AI into messaging system 102 includes configuring connection service 112 and/or conversation service 116 for the intake of user-reported absence information from user 104 via absence reporting service 202 on user terminal 106 by way of AI-based tools included as part of connection service 112 and/or conversation service 116. The connection service 112 of dialog module 130 may be software that utilizes AI (in any form, including ML, and more specifically specialized forms of ML including deep learning (DL)/neural networks (NN)).

The conversation service 116 may be software that may build software bots (such as chatbot 302) with conversational AI that understands intent, maintains context, and automates simple tasks across many languages, and may be configured to provide for designing and deploying omnichannel conversational AI without dedicated hardware or infrastructure being needed by the absence system provider entity (e.g., the company) utilizing the conversation service 116 as part of ARM system 100. The conversation service 116 may be further configured to build conversational interfaces using natural language processing (NLP) and associated models as part of absence reporting service 202, and to be responsive to various user inputs such as text (or other user inputs such as picture, voice, or emoji icons such as a “thumbs up” emoji icon). Chatbot 302 may be configured such that response generator 220 and response transmitter 222 (each shown in FIG. 2) are integrated therein, or response generator 220 and response transmitter 222 may otherwise be operatively connected to chatbot 302 so that chatbot 302 can provide responses to input 206 (shown in FIG. 2) in association with the functions provided by response generator 220 and response transmitter 222.

Beyond models 304, the backend computing system 110 may also include one or more models 306 that may be trained on data from any of databases 212, 214, 216, and 236, for example, and utilized for any business purpose of the company. In some embodiments, a model 306 trained on data from message database 212 may learn to detect patterns and other valuable information regarding employee absences. In one instance, input receiver 208 may be configured to extract the date/time the input 206 was received by the input receiver 208, where the extracted date/time information is stored in message database 212. The cumulative date/time data stored in message database 212 from a plurality of employees that have reported their absence could, over time, be used to train an ML model implemented as model 306. Such an ML model could learn aspects of absence reporting, such as how soon before the start of an employee's shift an employee tends to report their absence. For example, once a sufficient amount of training data is available in message database 212, an ML model implemented as model 306 could learn that on average, employees call out 45 minutes before the start of their shift (in other words, the company is only provided with 45 minutes of notice in order to be able to accommodate and/or mitigate the absence). This insight could be valuable in revising or setting employee handbook policies regarding absences, since the closer to the start of a shift that an employee calls out absent, the more harmful it is to the company which then has the challenge of attempting to find last-minute coverage for the missing employee and dealing with the related negative impacts. Another example model 306 includes a model trained on absence data from absence database 236 to learn which types of absences are most common, including seasonal (e.g., holiday) trends, or other notable patterns. For example, an ML model trained on absence data from absence database 236 and implemented as a model 306 may learn that full-day absences are most common, followed by partial-day absences, followed by multi-day absences (e.g., least common). These are just a few examples of how model(s) 306 could be trained and implemented with data obtained through messaging system 102.

Each of model(s) 304 and model(s) 306 may interface and be guided by respective sets of rules stored in a model rules database 308. Model rules database 308 may include algorithms that establish (i) rules for model(s) 304 that define how messages of user 104 are analyzed and responses of chatbot 302 are generated, and (ii) rules for model(s) 306 that define which types of data to extract from input(s) 206. While model(s) 306 and model rules database 308 are shown in FIG. 3 as being encompassed within backend computing system 110, model(s) 306 and model rules database 308 may be implemented within other aspects of ARM system 100. For example, model rules database 308 may be integrated in messaging system 102, or more specifically in dialog module 130. Models 304 and 306 may be trained on sample data such as sample call center scripts or sample absence hotline scripts, but may also be trained on data obtained from usage of ARM system 100. Models 304 and 306 may be configured for continuous learning, including being iterated and refined over time to refine algorithms thereof, enhance data quality, and optimize performance and parameters.

In some embodiments, the connection service 112 may further be configured in the form of contact center software integrated with the AI-based functionality as described herein for responding to absence-based messages. As such, chatbot 302 may be specifically configured as a virtual agent/AI chatbot to provide conversational solutions that provide responses and self-service capabilities such as absence reporting via dialog module 130. For example, the chatbot 302 may be trained and designed using existing transcripts and data from an absence hotline used by a company to record employee absences, which may be stored in response database 224. Having connection service 112 and conversation service 116 operatively interconnected as part of dialog module 130 improves flow and productivity of the messaging system 102. Compute service 114 may further be configured to communicate with conversation service 116 regarding requests and retrieval of user information, and conversation service 116 may be further configured to recognize that user/account information has been requested, for example as part of the process of verifying an identity of a user 104 that is reporting an absence to the absence reporting service 202 of the messaging system 102 via their user terminal 106. AI aspects may also be integrated in or usable with input receiver 208 in connection with parsing input 206.

In some other embodiments, connection service 112 and conversation service 116, and/or compute service 114 may be a suite of web-based services provided/managed by a singular web/cloud services provider and able to be seamlessly integrated with one another, such that synergistic applications as described herein can be built that automatically scale up and down and run in highly configurable implementations across multiple data centers, reducing administrative effort required for scalability, back-ups, or multi-data center redundancy, with the ability to query data, execute business logic, and monitor performance. By integrating connection service 112, compute service 114, and conversation service 116, real-time serverless data processing systems can be realized and utilized in the messaging system 102 as described herein to provide conversation via (e.g., text) messaging, to realize an AI-based chatbot 302 for a user 104 to converse with when using messaging system 102 to report their absence.

### Exemplary Chatbot Application

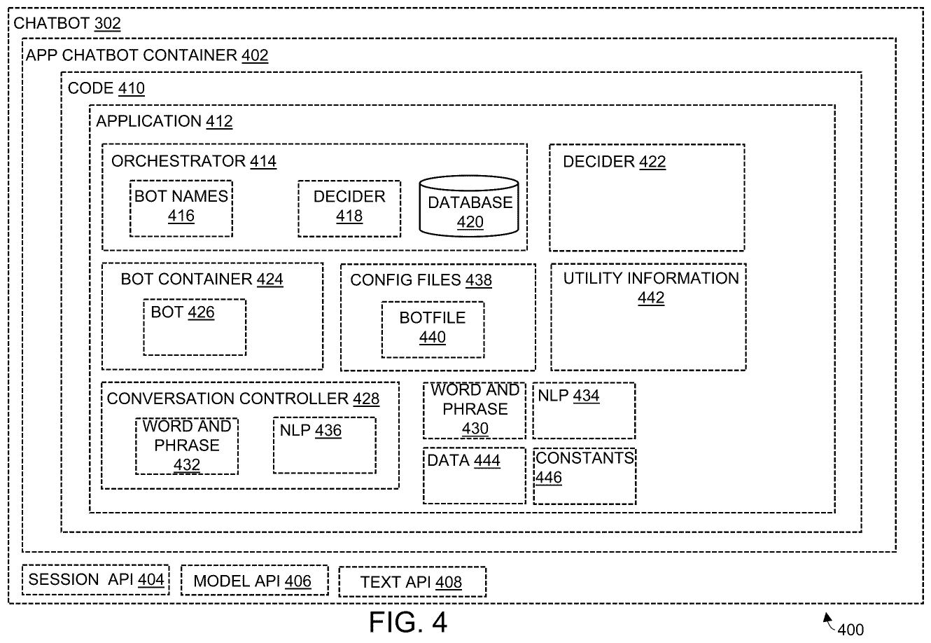

FIG. 4 illustrates a simplified block diagram of a chat application 400 for chatbot 302 as shown in FIG. 3, in accordance with the present disclosure. In the exemplary embodiment, chat application 400 is executed in dialog module 130 (shown in FIG. 1) and the computing devices thereof.

In the exemplary embodiment, the chat application 400 may execute an app chatbot container 402 such as an “app service.” The chat application 400 may include application programming interfaces (APIs) for communication with various systems, such as, but not limited to, a session API 404, a model API 406 for communicating with the models 304 (shown in FIG. 3), and a text API 408 for parsing text.

The container 402 may include code 410 and an executing app 412. The executing app 412 may include an orchestrator 414 which may orchestrate communications amongst various communication channels within ARM system 100. An instance of the orchestrator 414 may be contained in the code 410. The orchestrator 414 may include multiple instances of bot names 416, a decider 418, and one or more databases 420. The orchestrator 414 may also include a decider instance 422 of decider 418. The executing app 412 may include a bot container 424 which includes one or more sub-bots 426, each of which has its own functionality. In some embodiments, bot names 416 may correspond to sub-bots 426, and the sub-bots 426 may each be programmed to handle different types of data, such as absence data and/or user data. The decider instance 422 may contain the logic for routing information and controlling sub-bots 426. The orchestrator 414 also may include access to the one or more databases 420, which may be similar to databases 216 and 228 (shown in FIG. 2).

The executing app 412 may also contain a conversation controller 428 for controlling the communication between the user 104 and the chatbot 302. An instance of the conversation controller 428 may be stored in the code 410. The conversation controller 428 may control a word and phrase instance 430 of a word and phrase (e.g., text) component 432 and an NLP instance 434 of an NLP component 436. The executing application may also include config files 438, which may include botfiles 440 (e.g., local and/or master). The executing app 412 may further include utility information 442, data 444, and constants 446 to execute its functionality.

The above description is a simplified description of a chat application 400 that may be used with the systems and methods described herein. However, the chat application 400 may include less or more functionality as needed.

### Exemplary Data Flow

FIG. 5 illustrates a block diagram of an exemplary flow of data 500 in accordance with the process 300 (shown in FIG. 3) using ARM system 100 (shown in FIG. 1). In the exemplary embodiment, a message 502 is received, for example, at backend computing system 110 (shown in FIG. 1) via platform 108 (shown in FIG. 1) and handled and processed by messaging system 102 (shown in FIG. 1). Message 502 may be a written (e.g., typed) message entered by user 104 into absence reporting service 202 (shown in FIG. 2) to engage with absence reporting service 202, where chatbot 302 (shown in FIG. 3) is the component of messaging system 102 that user 104 converses with via absence reporting service 202 on user terminal 106. Input receiver 208 (shown in FIG. 2) may parse the message 502 and comparison module 210 (shown in FIG. 2) may compare aspects of parsed message 502 to rules in input rules database 216 (shown in FIG. 2) to identify parameters of message 502, as described herein.

Chatbot 302, for example via response generator 220, may determine an intent 504 of the message 502, such determined intent being of use by chatbot 302 in generating a response to message 502. Chatbot 302 may extract data 506 (e.g., a meaning of the message) and generate a response 508 (e.g., a reply to the message or a request for more information) based upon the extracted data 506. As described herein, chatbot 302 may be a software application programmed to analyze messages related to employee data and employee absence data. More specifically, chatbot 302 may be programmed to analyze for a specific intent 504 to retrieve the data 506 from the message 502 related to that intent 504 and to generate a response 508 based upon the extracted data 506. In some embodiments, input 206 (shown in FIG. 2) may include the text and underlying data of message 502.

The process steps included between receiving message 502 and providing response 508 are repeated via loop 510 until all necessary absence information (shown in FIG. 6) for that particular absence session is confirmed. Then an update flag 512 may be set such that messaging system 102 causes an update routine 514 to run for the updating of services 120 and 122 with the confirmed absence information. Update routine 514 may include any necessary code or other software (e.g., API) to incorporate the confirmed absence information acquired via the conversation process into the necessary databases (e.g., databases/servers 146, 148) of services 120 and 122 for updating and propagating the new absence information. Meanwhile (e.g., while the update routine 514 completes and services 120 and 122 are updated), messaging system 102 is programmed to constantly look for and detect 516 a new user (e.g., a new message from a new user) via loop 518, which would then start the processes of flow of data 500 for the new user. The blocks shown in FIG. 5 are executed by the applicable aspects of ARM system 100 as described herein. For example, the processes associated with block 516 may be programmed to be keyed off of a particular start keyword such as “Hi” (e.g., user 104 initiates the absence reporting process by typing “Hi” into the text entry interface of absence reporting service 202 and hitting the send icon).

In some embodiments, update routine 514 may utilize a JSON scheme including JSON pathways for performing data operations for the updating of workflow management service 120 by connection service 112 and/or compute service 114. Connection service 112 may include predefined attributes which can be referenced. Such attributes may include, but are not limited to, system attributes, telephony metadata attributes, a plurality of contact attributes, company-defined attributes, flow attributes, profile attributes, and outbound campaign attributes.

For example, in a JSON scheme, the system attributes may include a dialed number attribute that functions to identify the phone number of user terminal 106 used to contact absence reporting service 202. The dialed number attribute could be included in user records, or, when used as a function of compute service 114, included as an input object under a SystemEndpoint group. A corresponding JSONPath reference may be “$.SystemEndpoint.Address”. Additionally, the system attributes may include a Contact ID attribute representing a unique identifier of the contact, such as an alias of user 104. A corresponding JSONPath reference may be “$.ContactId”. These are just two examples of a plurality of system attributes. Such a JSON scheme may also include a plurality of telephony metadata attributes, which may include a “From” attribute relating to an identity of user 104, and have a JSONPath reference of “$.Media.Sip.Headers.From”. The JSON scheme may also include contact attributes, such as attributes for conversation service 116. This may include a plurality of intent-based attributes, for example an intent confidence score attribute which relates to an intent confidence score returned by conversation service 116, such as when chatbot 302 is determining intent of a user message/response during a conversation with the user. This may have a JSONPath reference of $.ConversationService.IntentConfidence.Score”. A contact attribute of connection service 112 may include a date/time opened attribute representative of a date/time that a conversation was started by a user 104 in absence reporting service 202. This may have a JSONPath reference of “$.Case.created_datetime”, and may be implemented or otherwise used in connection with a visual date/time stamp to provide a visual reference to a start time of the conversation within an interface of the conversation.

Additionally, conversation service 116 may include various (e.g., contact) attributes including which may be returned as key-value pairs from a most recent invocation of an “invoke conversation service” function block. External attributes may be overwritten with each invocation of the conversation service function. To reference external attributes in JSONPath, the JSONPath reference “$.External.attributeName” may be used where AttributeName is the attribute name, or the key of the key-value pair returned from the function. For example, if the function returns a contact ID, referencing the attribute with $.External.ContactId may be used. When referencing a contact ID returned from connection service 112, the JSONPath may be $.ContactId. These are just some examples of additional attributes utilized by services 112, 114, 116.

To pass attributes and parameters between functions of the compute service 114 and connection service 112, a function is configured to correctly parse a JSON request sent from an invoke conversation service function block or set contact attributes, and define any business logic that should be applied. How the JSON is parsed may depend on the runtime used for any particular function. Regarding the various JSONPath references, the leading $ character represents the root object or array.

In the exemplary embodiment, messaging system 102 and the applicable components thereof may be configured to execute blocks 502-518. Without limitation, conversation service 116 may be configured to execute blocks 502, 504, 506, 508 and compute service 114 may be configured to execute blocks 512, 514, 516, and loops 510 and 518. Additionally, or alternatively, connection service 112 may be configured to execute all or part of the code of the blocks of flow of data 500, or any combination of services 112, 114, 116 (including any aspects thereof, such as integration module 150) may do so. In some embodiments, a non-AI script can be used in place of chatbot 302, such script being programmed to respond to user messages based on the rules of the script. A non-AI script may be programmed to perform the specific question routine for obtaining the necessary absence information, but in a more limited manner than an AI-based chatbot 302.

### Exemplary Messaging Flow

FIG. 6 illustrates a flow chart of an exemplary process 600 for reporting an absence using the messaging system 102 of ARM system 100 (shown in FIG. 1). In the exemplary embodiment, a conversation according to process 600 is carried out between user 104 and the chatbot 302 (e.g., via dialog module 130), exchanging messages 502 (shown in FIG. 5) and responses 508 (shown in FIG. 5) until the absence information is collected and confirmed, and the absence reporting session is completed/closed. The flow chart of process 600 may be representative of a flow of call center script that has been tailored for absence reporting, and/or representative of scripts used to train model 304 in connection with and implemented by chatbot 302. Model 304 may have additionally or alternatively been trained on other call center transcripts so as to be provided in a ready to use state by the provider of services 112 and 116, and/or customized by the provider for the particular needs of the company intending to use chatbot 302 based on (e.g., training data) materials provided to the provider by the company. While FIG. 6 indicates chatbot 302 asking questions and providing prompts, this could alternatively be done using a non-AI programmed script, and as such process 600 does not require a chatbot. The various blocks shown in FIG. 6 are representative of (e.g., text) messages exchanged between user 104 and chatbot 302. Alternatively, the various blocks shown in FIG. 6 may be representative of (e.g., text) messages exchanged between user 104 and a script configured to execute the absence reporting process (e.g., in an embodiment where chatbot 302 is not present or utilized within messaging system 102, and conversational aspects are performed by the script).

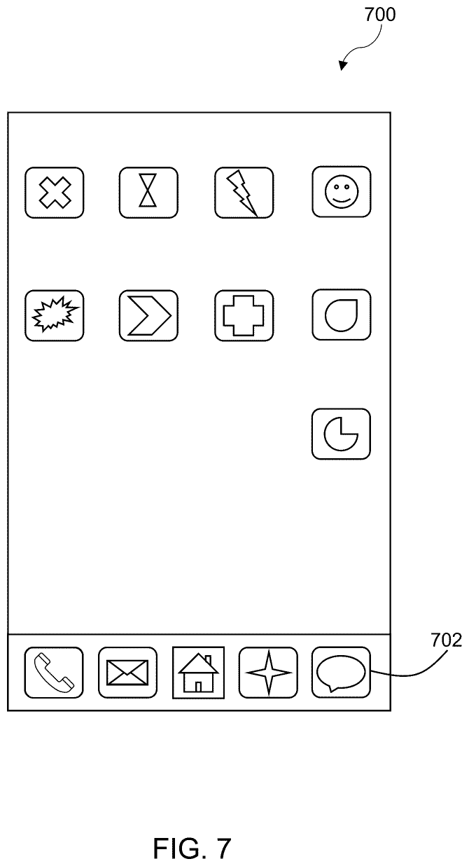

Within absence reporting process 600, at block 602 the user 104 initiates an absence reporting session by using absence reporting service 202 on their user terminal 106. This may include user 104 opening the text messaging application 702 (shown in FIG. 7) on their user terminal 106, or opening a dedicated absence reporting application 802 (shown in FIG. 8) on their user terminal 106, depending on how the absence reporting service 202 is implemented on the user terminal 106. To initiate the absence reporting session at block 602, user 104 may enter a start keyword such as “Hi” into the text entry interface of absence reporting service 202 which will trigger chatbot 302 to start conversing with user 104. At block 604, chatbot 302 confirms an active absence reporting session has started. At block 606, chatbot 302 asks user 104 to enter identifying information such as an alias associated with user 104. For example, user 104, as an employee, may have been provided a unique alias similar to an employee ID by their employer (e.g., company) at hiring. This alias is linked to an employee profile of user 104 within the company's records (e.g., within user database 214 of backend computing system 110). The alias may be a multi-character code, such as a 4-character code made up of random letters, numbers, and/or symbols. At block 608, user 104 enters their alias into the text entry interface of absence reporting service 202.

At block 610, chatbot 302 performs a look-up to the applicable database (e.g., user database 214), confirms that the alias exists within the company's records, and retrieves and presents the relevant information associated with the alias to user 104 via the text interface of absence reporting service 202. In some embodiments, this may be accomplished using look-up module 118 in conjunction with comparison module 210, input rules database 216, and/or user database 214. For example, the matching rules of input rules database 216 may include a set of alias matching rules for determining a match between an alias provided by the user as part of the absence reporting process and an alias stored within a database of ARM system 100. This may further include retrieving a name associated with the alias in the company's records when a match is determined to exist, and may be accomplished by a query to find and retrieve name information associated with an alias via a table (e.g., a look up table) provided in user database 214. At block 612, chatbot 302 asks user 104 to confirm the accuracy of the (e.g., name) information, for example that the name is accurate. This may include prompting the user 104 to enter a certain alphanumeric response into the text interface to confirm the accuracy of the name or provide other input. For example, chatbot 302 may ask user 104 to type “1” if the retrieved name information is correct, or type “2” if the name is incorrect (where the user 104 will then need to re-enter their alias (e.g., in the case where an improper alias may have been initially entered by user 104, such as due to transposed digits of the alias)).

At block 614, user 104 types “1” or “2” depending on if the retrieved name was accurate. If user 104 enters “2”, the name identification process will start over (e.g., at block 606). If user 104 enters “1”, at block 616 the chatbot 302 asks user 104 to enter another different identifier stored in company records in association with user 104. This additional identifier may include a pin number for a line of business that the employee is associated with or belongs to at the company, and may be a 4-digit alphanumeric code. Information relating to line of business is helpful in providing the workflow updates to workflow management service 120 and email service 122 so that the appropriate personnel (e.g., personnel in the same line of business) within the company are notified of the absence of the employee once the absence reporting process has completed.

At block 618, user 104 enters the pin number for the line of business. At block 620, the chatbot 302 presents the name of the line of business to user 104 and asks user 104 to confirm the accuracy of the line of business by entering “1” if correct, and “2” to change. In some embodiments, this may be accomplished using look-up module 118 in conjunction with comparison module 210, input rules database 216, and/or user database 214. For example, the matching rules of input rules database 216 may include a set of line of business matching rules for determining a match between line of business information provided by the user as part of the absence reporting process and line of business information stored within a database of ARM system 100. Chatbot 302 retrieves the line of business name based on there being a match between the line of business pin number entered by the user with a line of business pin number present within company records, such as may be stored in user database 214 or another database of backend computing system 110. This may be accomplished by a query to find and retrieve line of business information associated with the pin via a table (e.g., a look up table) provided in the applicable database. If user 104 enters “2”, the line of business pin number process will start over (e.g., at block 616). If user 104 enters “1”, at block 622 the chatbot 302 confirms the line of business as being accurate.

At block 624, chatbot 302 asks user 104 to confirm the time zone from which they are calling from or from which their residence data as stored within the company system indicates. The time zone information may be associated with user 104 within user database 214 and pre-stored in user database 214 for retrieval as described herein (e.g., via query/look up table). However, because the time zone may vary depending on if the user 104 is travelling for work or otherwise not in the typical homebase location for work, messaging system 102 may be configured to extract dynamic time zone information from the user terminal 106 to determine time zone. This may be accomplished by input receiver 208 (shown in FIG. 2). For example, input receiver 208 may extract time zone information from input 206, and store the extracted time zone information in message database 212 or session database 234 for retrieval by chatbot 302 as part of the time zone confirmation process. If user 104 enters “2”, the time zone process will start over (e.g., at block 624). If user 104 enters “1”, the time zone is confirmed and process 600 proceeds from the user information intake stage to an absence inquiry stage, where blocks 602-626 may be representative of the user information intake stake, and blocks 628-634 may be representative of the absence inquiry stage.

Once the necessary user identification information (e.g., alias, name, line of business, time zone) has been collected and verified, process 600 then inquires about absence-specific information. At block 628, chatbot 302 asks user 104 the type of absence, and prompts user 104 to enter “1” for an all-day (aka full-day) absence or “2” for a late arrival. At block 630, user 104 confirms the type of absence by entering “1” or “2” depending on the type of absence. At block 632, chatbot 302 then asks user 104 if the absence is related to illness, and prompts user 104 to enter “1” if yes and “2” if no. At block 634, user 104 enters “1” or “2” depending on if the absence is related to illness or not.

Once the chatbot 302 has collected all of the absence-specific information from user 104, at block 636 chatbot 302 presents user 104 with certain collected information, including name, alias, and type of absence, and may also ask user 104 for confirmation of the date of absence (such a date may have been automatically extracted by input receiver 208 from input 206). At block 638, chatbot 302 then instructs user 104 to wait for a final confirmation. At block 640, chatbot 302 prompts user 104 to enter “1” if the content in block 636 is correct, “2” to start over, or “3” to cancel the absence request. At block 642, user 104 enters “1”, “2”, or “3.” If user 104 enters “1”, at block 644 chatbot 302 presents a response confirming the absence and indicating that the session has ended. If user 104 enters “2”, at block 646 the absence reporting process starts over (e.g., back to block 602). If user 104 enters “3”, at block 646, chatbot 302 cancels the absence request and closes the session.

In some embodiments, for each response by chatbot 302 described herein in connection with FIG. 6, a reference may be made to model 304 associated with chatbot 302 to determine the appropriate response. Each response is generated based on model 304, which may have been trained on sample scripts and on actual responses accumulated over time via ARM system 100 as described herein. The responses may also be guided by rules such as in response database 224 (shown in FIG. 2) and model rules database 308 (shown in FIG. 3). In some further embodiments, the questions asked in process 600 may vary based on what identifying or other information is desired, which may be set in advance by the company. For example, the questions or prompts presented by chatbot 302 may also cover reporting an early departure, or reporting planned absences (e.g., multi-day) instead of single day (such as a vacation). The blocks 602 to 648 in FIG. 600 are merely one example of an absence reporting message flow, and other flows including other questions/prompts/responses may be utilized. There may be a timeout provision where if no response is received from user 104 within a certain timeframe at any particular block, the absence reporting process is canceled and/or otherwise starts over (e.g., at block 602). This timeout function may be programmed and stored as an operational parameter of dialog module 130. In some embodiments, details regarding the start, duration, and end of absence reporting sessions may be stored in session database 234 and/or absence database 236, and a model 306 may be trained on such session data to extract valuable information on session parameters. Such a model 306 could then be utilized by the company to improve the ARM system 100 or company practices in any number of ways, such as by virtue of learning details about employee absence behavior. Such learned behavior may be used by the company for other business purposes.

### Exemplary Interfaces

FIGS. 7-20 illustrate exemplary user interfaces generated by or otherwise provided in association with messaging system 102 (shown in FIG. 1), for display on a user terminal device (similar to or the same as user terminal 106 shown in FIG. 2) associated with a registered user of the absence reporting service, such as user 104 (shown in FIG. 1).

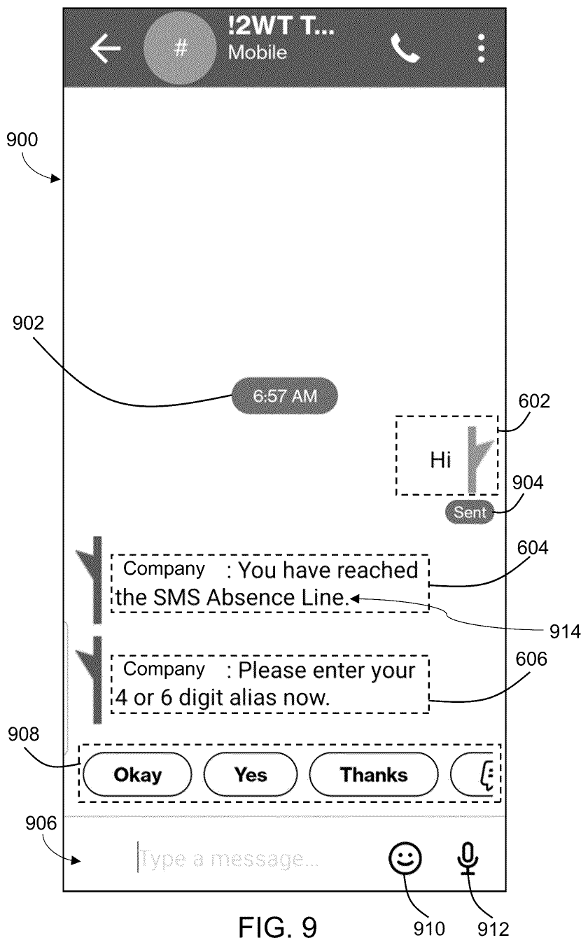

FIG. 7 illustrates an interface 700 where absence reporting service 202 (shown in FIG. 2) is implemented via an icon linked to a text messaging application 702 of a user terminal similar to or the same as user terminal 106 (shown in FIG. 2). In the exemplary embodiment, interface 700 is a user interface of user terminal 106 associated with user 104, and may be implemented as part of user interface 204 (shown in FIG. 2) of user terminal 106. For example, interface 700 may be a native user interface of the operating system (OS) of the user terminal 106. Text messaging application 702 of user terminal 106 may be provided by the operating system (OS) of the user terminal 106, and may be a native or stock text messaging interface included as part of the OS. User 104 selects the icon associated with text messaging application 702 (e.g., via touch screen selection of the icon of text messaging application 702) which thereby opens a user interface (such as the user interface shown in FIGS. 9-20) of the text messaging application 702, permitting user 104 to enter and send text messages via messaging system 102 (shown in FIG. 1) as part of the absence reporting process. The absence reporting session may be initiated by entry of a specific keyword into the text entry interface of the absence reporting service, which the text messaging application 702 recognizes as a start word for the start of an absence reporting session. The keyword may be sent to a toll free number or a 5 or 6 digit short code (e.g., an SMS short code) that is connected to the absence reporting service 202 of ARM system 100. For example, block 602 (shown in FIG. 6 and FIG. 9) is representative of a user 104 initiating an absence reporting session via text messaging application 702.

FIG. 8 illustrates an interface 800 where absence reporting service 202 (shown in FIG. 2) is implemented via an icon linked to an absence reporting application 802 of a user terminal similar to or the same as user terminal 106 (shown in FIG. 2). In the exemplary embodiment, interface 800 is a user interface of user terminal 106 associated with user 104 and may be implemented as part of user interface 204 (shown in FIG. 2) of user terminal 106. For example, interface 800 may be a native user interface of the operating system (OS) of the user terminal 106. Absence reporting application 802 of user terminal 106 may be downloadable and installable to user terminal 106, and may be configured as a dedicated application that is available from an application download store associated with the OS of user terminal 106, or otherwise downloadable onto user terminal 106 (e.g., via a dedicated download link provided by the provider of the application 802). User 104 selects the icon associated with absence reporting application 802 (e.g., via touch screen selection of the icon of absence reporting application 802) which thereby opens a user interface (such as shown in FIGS. 9-20) of the absence reporting application 802, permitting user 104 to enter and send text messages via messaging system 102 (shown in FIG. 1) as part of the absence reporting process. The absence reporting session may be initiated by entry of a specific keyword into the text entry interface of the absence reporting application 802 which is recognized by the absence reporting application 802 as a start word for the start of an absence reporting session. The absence reporting application 802 may be associated with a toll free number or a 5 or 6 digit short code (e.g., an SMS short code) associated with ARM system 100, and the keyword may be sent via absence reporting application 802 to the toll free number or SMS short code as part of initializing the session with absence reporting service 202. For example, block 602 (shown in FIG. 6 and FIG. 9) is representative of a user 104 initiating an absence reporting session via absence reporting application 802.

FIGS. 9-20 illustrate a messaging interface and a series of messages exchanged between user 104 (shown in FIG. 1) and the chatbot 302 (shown in FIG. 3) of messaging system 102 (shown in FIG. 1) that are representative of the messaging flow of process 600 shown in FIG. 6. The interface(s) shown in FIGS. 9-20 is/are representative of a user interface that may be utilized as the user interface of either the text messaging application 702 (shown in FIG. 7) or the absence reporting application 802 (shown in FIG. 8).

FIG. 9 illustrates an interface 900 of either of text messaging application 702 or absence reporting application 802, illustrating an exchange of messages between user 104 (shown in FIG. 1) and chatbot 302 (shown in FIG. 3), where such messages are representative of blocks 602, 604, and 606 (shown in FIG. 6). Interface 900 may include a message date/time stamp 902, a message transmission confirmation 904, and access to a text entry interface 906 and predictive/common responses 908 that are selectable by user 104, as well as alternate message entry options such as character selector 910 for selection of alternate characters such as emojis, and microphone selector 912 for triggering voice recording for voice entry aspects. While date/time stamp 902 is illustrated in FIG. 9 as only showing time information, it may be configured to show date and time. Date/time stamp 902 may be a visual representation of certain underlying data included with message transmission data of the message received from user terminal 106.

For example, the above-described contact date/time attribute of connection service 112 (e.g., having a JSONPath reference of “$.Case.created_datetime”) may be implemented or otherwise used in connection with a date/time stamp 902. In some embodiments, the time may be required to be formatted in universal time, and a function of compute service 114 may relate to time zone conversions. For example, a conversion function may be implemented to handle all date/time conversions for any time zone of the plurality of employees reporting an absence in a particular manner, where such function (e.g., lambda) may be used to provide custom time conversion manipulations as needed, for example to account for the various time zones of employees as well as the time formats that may be required for each of the platforms, services, and/or sub-systems of ARM system 100 (e.g., to accommodate the particular time requirements of platform 108, etc.).

In some other embodiments, absences may only be allowed same day if initiated by a user before a certain time, such as the official time the company operates at (e.g., U.S. central time zone). For example, 8:00 pm US Central time may be set by the company as a cut-off time for same-day absence reporting. If an employee initiates the absence reporting process after 8:00 pm US Central time, chatbot 302 may offer a next day absence due to being past the same-day cut-off time. A dedicated lambda may be used to execute such next day absence functionality. Message transmission confirmation 904 may be configured to display a word indicating successful transmission, such as “Sent” (or alternatively “Not Delivered” if the message was not delivered). Text entry interface 906 may include user interface (UI) features such as a cursor and faded text (e.g., “Type a message”) to emphasize to user 104 the location of the active text field of text entry interface 906 where user 104 should select (e.g., touch) in order to enter text (e.g., via an onscreen keyboard of the OS of user terminal 106, not shown). Predictive/common responses 908 may be native to text messaging application 702 (shown in FIG. 7) or absence reporting application 802 (shown in FIG. 8), and may be programmed to include predictive responses (e.g., “Yes”) that are frequently used within messaging system 102 for responding to chatbot 302, for example. Dialog module 130 may also be configured to recognize emojis entered via character selector 910 or voice entered via microphone selector 912 as responses to questions asked by chatbot 302 as an alternative to user 104 using only text to communicate with chatbot 302.

In this regard, a “smiley face” or “thumbs up” emoji may be treated by dialog module 130 as being representative of a confirmatory “YES” response by user 104, and an audible voice response of “YES”, or “ONE” or “TWO” may be recognizable by chatbot 302 as acceptable responses. In some embodiments, data representative of the information conveyed by date/time stamp 902 and/or transmission confirmation 904 may be stored in databases such as session database 234 and/or absence database 236 for use in training models 306 and/or being evaluated by models to detect patterns and/or extract other valuable information, which may be used to improve ARM system 100 or for any other business purposes of the company operating ARM system 100. At block 604, the response may include a name 914 of the absence reporting service provided by the company, such as “SMS Absence Line.”

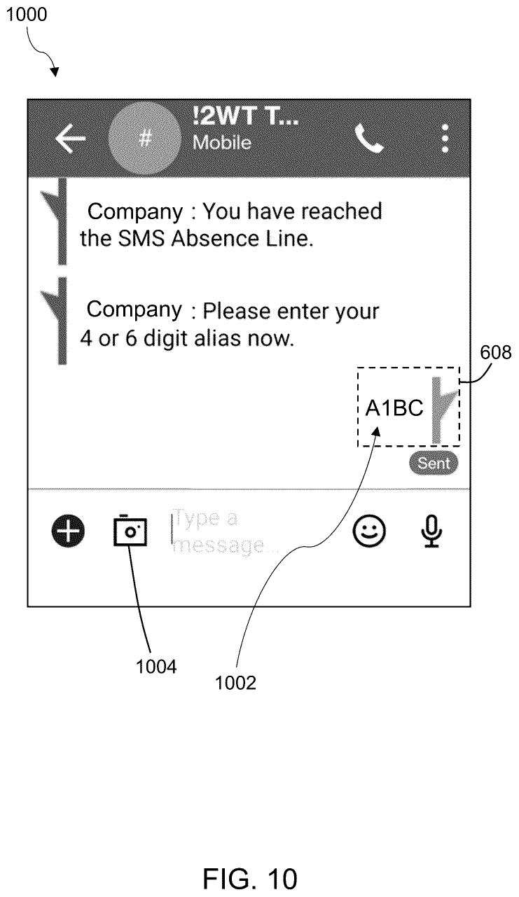

FIG. 10 illustrates an interface 1000 that is a next iteration of the conversation taking place within interface 900 (shown in FIG. 9) between user 104 (shown in FIG. 1) and chatbot 302 (shown in FIG. 3), and therefore has common features as interface 900 (shown in FIG. 9), such as a text entry interface (906 as shown in FIG. 9), alternate message entry options (e.g., 910 and 912 as shown in FIG. 9), and a message transmission confirmation such as “Sent” (904 as shown in FIG. 9). Interface 1000 illustrates further exchange of messages between user 104 and chatbot 302, where such messages are representative of block 608 (shown in FIG. 6). The text entered in connection with block 608 may include an alias 1002, which, as described herein, may be a 4-character code such as “A1BC” associated with user 104 in the records of the company that employs user 104, used for identifying user 104 as an employee of the company. Interface 1000 also illustrates that the alternate message entry options may include the ability to utilize photos/images for providing responses by way of camera selector 1004. For example, camera selector 1004 may be configured to permit user 104 to take and send a picture of their face for purposes of identification, or a picture of a doctor's note in connection with verifying absence information due to sickness. In this regard, chatbot 302 may be configured to process and compare any picture submitted via use of camera selector 1004 to one or more photographs (for example a stored copy of a work badge photograph of an employee) that may be stored in a database of ARM system 100 such as in user database 214 for purposes of verifying users 104.

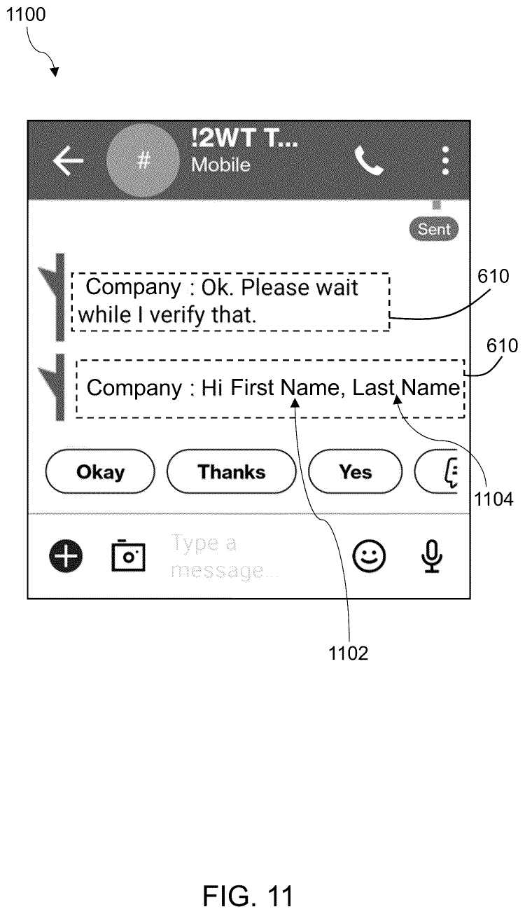

FIG. 11 illustrates an interface 1100 that is a next iteration of the conversation taking place in interface 1000 (shown in FIG. 10) between user 104 (shown in FIG. 1) and chatbot 302 (shown in FIG. 3), and has common features as interface 900 as described above in connection with FIG. 10. Interface 1100 illustrates further exchange of messages between user 104 and chatbot 302, where such messages are representative of block 610 (shown in FIG. 6). A first name 1102 of user 104 and a last name 1104 of user 104 may be presented in the response represented by block 610 after the first name 1102 and last name 1104 is retrieved from a corresponding database (e.g., user database 214) of ARM system 100 based on a match being determined between the alias entered by user (e.g., at block 608, shown in FIG. 6) and an alias stored in ARM system 100 and associated with first name 1102 and last name 1104, as described herein.

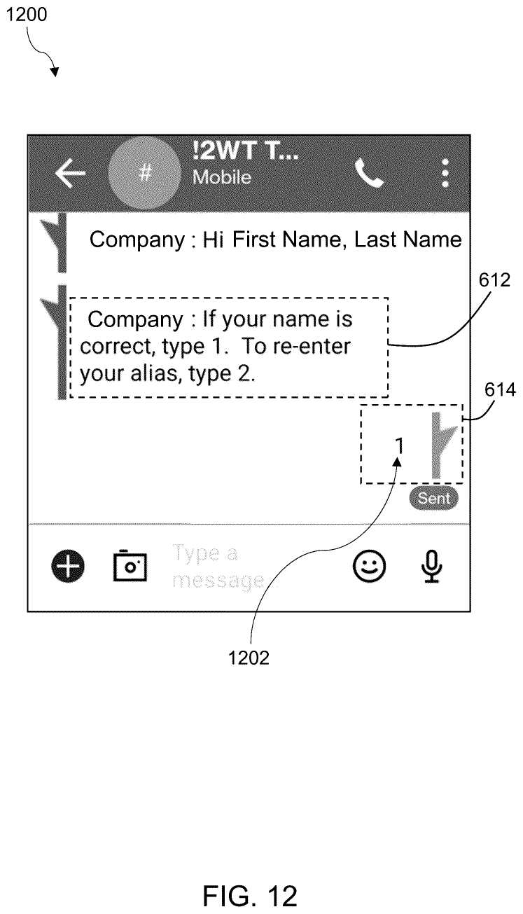

FIG. 12 illustrates an interface 1200 that is a next iteration of the conversation taking place in interface 1100 (shown in FIG. 11) between user 104 (shown in FIG. 1) and chatbot 302 (shown in FIG. 3), and has common features as interface 900 as described above in connection with FIG. 10. Interface 1200 illustrates further exchange of messages between user 104 and chatbot 302, where such messages are representative of blocks 612 and 614 (shown in FIG. 6). A user response digit 1202 may be present in block 614 in response to the message in block 612 regarding entering a digit (e.g., “1” or “2”) in connection with the accuracy of the retrieved name information in block 610.

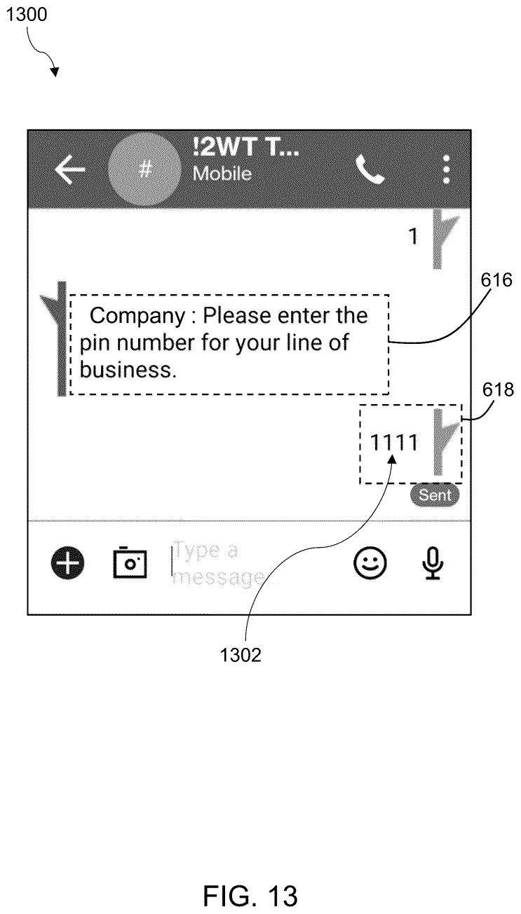

FIG. 13 illustrates an interface 1300 that is a next iteration of the conversation taking place in interface 1200 (shown in FIG. 12) between user 104 (shown in FIG. 1) and chatbot 302 (shown in FIG. 3), and has common features as interface 900 as described above in connection with FIG. 10. Interface 1300 illustrates further exchange of messages between user 104 and chatbot 302, where such messages are representative of blocks 616 and 618 (shown in FIG. 6). A line of business pin number 1302 may be present in block 618 in response to the message in block 616 regarding entering a line of business pin number.

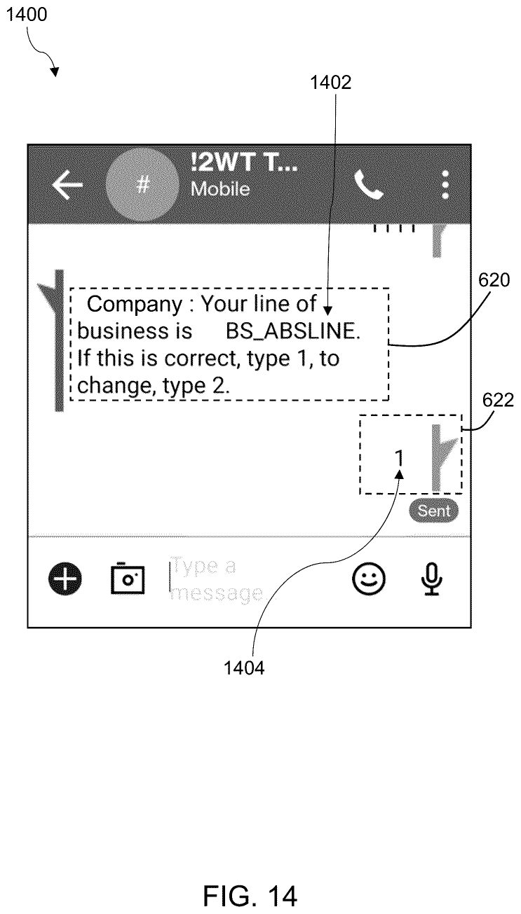

FIG. 14 illustrates an interface 1400 that is a next iteration of the conversation taking place in interface 1300 (shown in FIG. 13) between user 104 (shown in FIG. 1) and chatbot 302 (shown in FIG. 3), and has common features as interface 900 as described above in connection with FIG. 10. Interface 1400 illustrates further exchange of messages between user 104 and chatbot 302, where such messages are representative of blocks 620 and 622 (shown in FIG. 6). A line of business name 1402 may be presented in the response represented by block 620 after the line of business name 1402 is retrieved from a corresponding database of ARM system 100 based on a match being determined between the line of business information entered by user (e.g., at block 618, shown in FIG. 6) and the line of business information stored in ARM system 100, as described herein. A user response digit 1404 may be present in block 622 in response to the message in block 620 regarding entering a digit (e.g., “1” or “2”) in connection with the accuracy of the retrieved line of business name information in block 620.

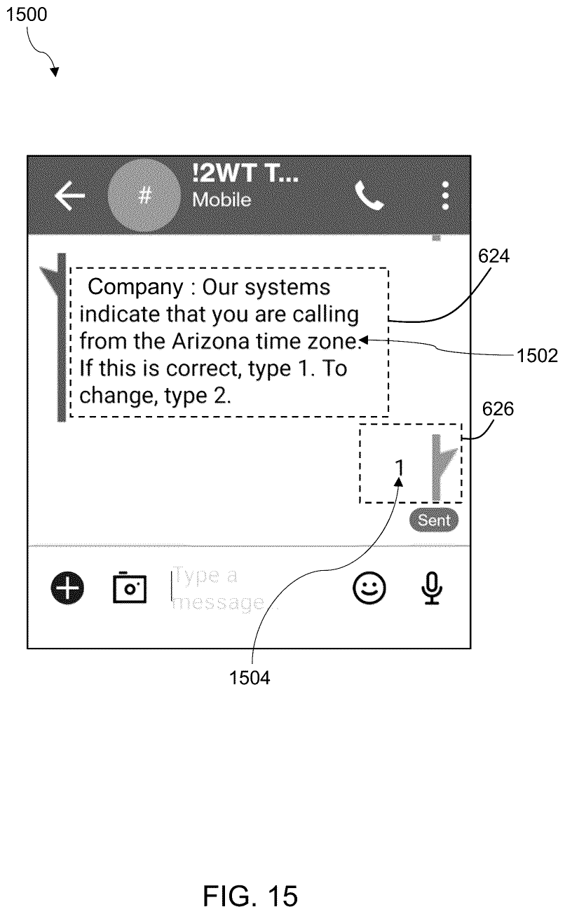

FIG. 15 illustrates an interface 1500 that is a next iteration of the conversation taking place in interface 1400 (shown in FIG. 14) between user 104 (shown in FIG. 1) and chatbot 302 (shown in FIG. 3), and has common features as interface 900 as described above in connection with FIG. 10. Interface 1500 illustrates further exchange of messages between user 104 and chatbot 302, where such messages are representative of blocks 624 and 626 (shown in FIG. 6). A time zone 1502 may be presented in the message represented by block 624 after the time zone information is retrieved from a corresponding database (e.g., user database 214, shown in FIG. 2) of ARM system 100 in which such time zone information was stored in association with other information pertaining to user 104. Alternatively, time zone 1502 may have been generated and presented based on analysis by messaging system 102 of underlying data (e.g., message data, terminal data (e.g., cell tower data)) from user terminal 106 regarding a location of user terminal 106 in which the initial message (e.g., at block 602, shown in FIG. 6) was sent from (e.g., a present location of user terminal 106 in a specific time zone), as described herein. A user response digit 1504 may be present in block 626 in response to the message in block 624 regarding entering a digit (e.g., “1” or “2”) in connection with the accuracy of the retrieved time zone information in block 624.

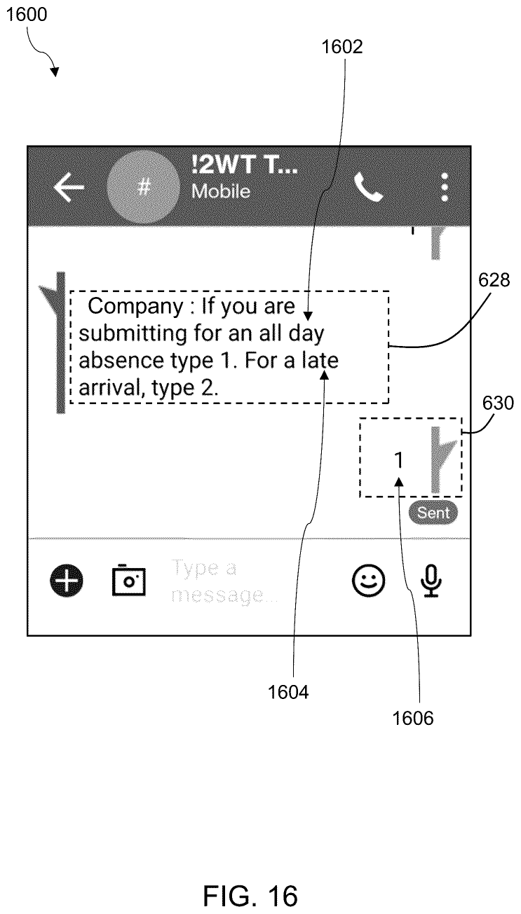

FIG. 16 illustrates an interface 1600 that is a next iteration of the conversation taking place in interface 1500 (shown in FIG. 15) between user 104 (shown in FIG. 1) and chatbot 302 (shown in FIG. 3), and has common features as interface 900 as described above in connection with FIG. 10. Interface 1600 illustrates further exchange of messages between user 104 and chatbot 302, where such messages are representative of blocks 628 and 630 (shown in FIG. 6). The message represented at block 628 may include a first type of absence 1602, which may be an “all day” absence, and a second type of absence 1604, which may be a “late arrival.” A user response digit 1606 may be present in block 630 in response to the message in block 628 regarding entering a digit (e.g., “1” or “2”) in connection with the type of absence.

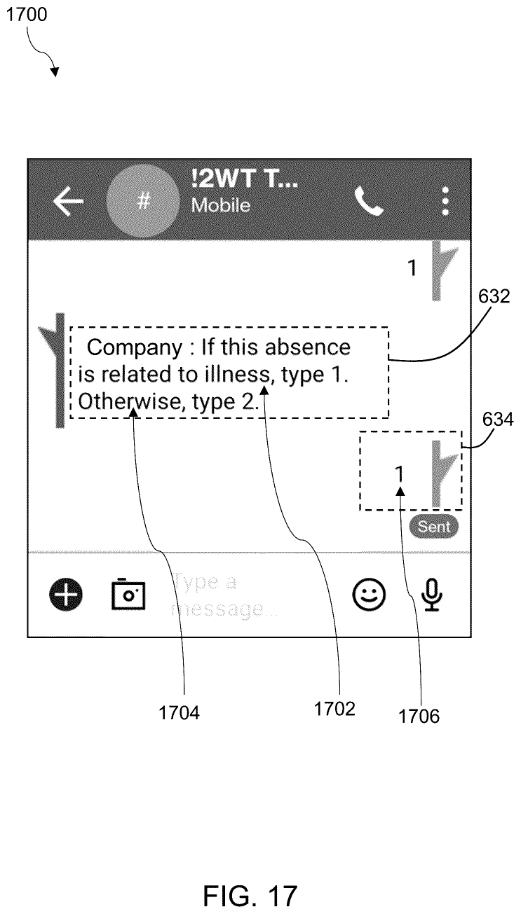

FIG. 17 illustrates an interface 1700 that is a next iteration of the conversation taking place in interface 1600 (shown in FIG. 16) between user 104 (shown in FIG. 1) and chatbot 302 (shown in FIG. 3), and has common features as interface 900 as described above in connection with FIG. 10. Interface 1700 illustrates further exchange of messages between user 104 and chatbot 302, where such messages are representative of blocks 632 and 634 (shown in FIG. 6). The message represented at block 632 may include a first basis for absence 1702, which may be “illness,” and a second basis for absence 1704, which may be “Otherwise.” A user response digit 1706 may be present in block 630 in response to the message in block 628 regarding entering a digit (e.g., “1” or “2”) in connection with the type of absence.

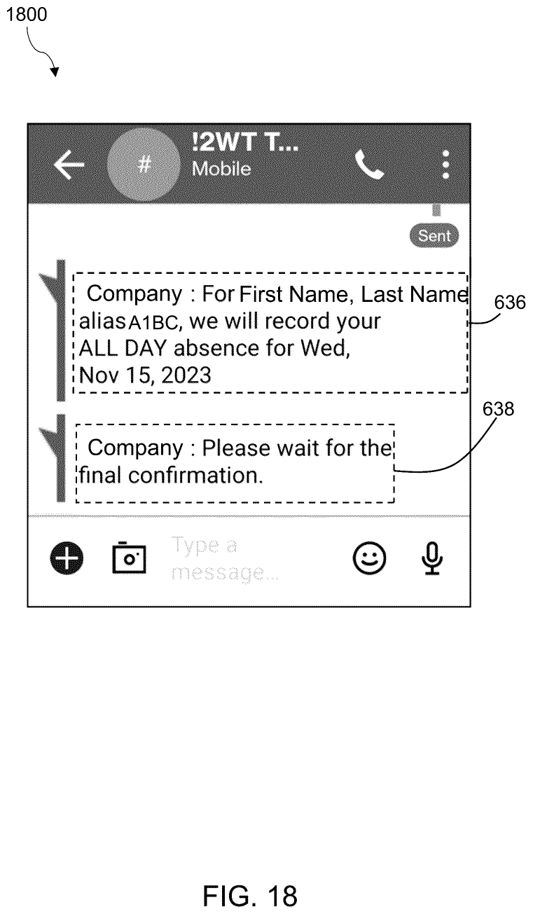

FIG. 18 illustrates an interface 1800 that is a next iteration of the conversation taking place in interface 1700 (shown in FIG. 17) between user 104 (shown in FIG. 1) and chatbot 302 (shown in FIG. 3), and has common features as interface 900 as described above in connection with FIG. 10. Interface 1800 illustrates further exchange of messages between user 104 and chatbot 302, where such messages are representative of blocks 636 and 638 (shown in FIG. 6).

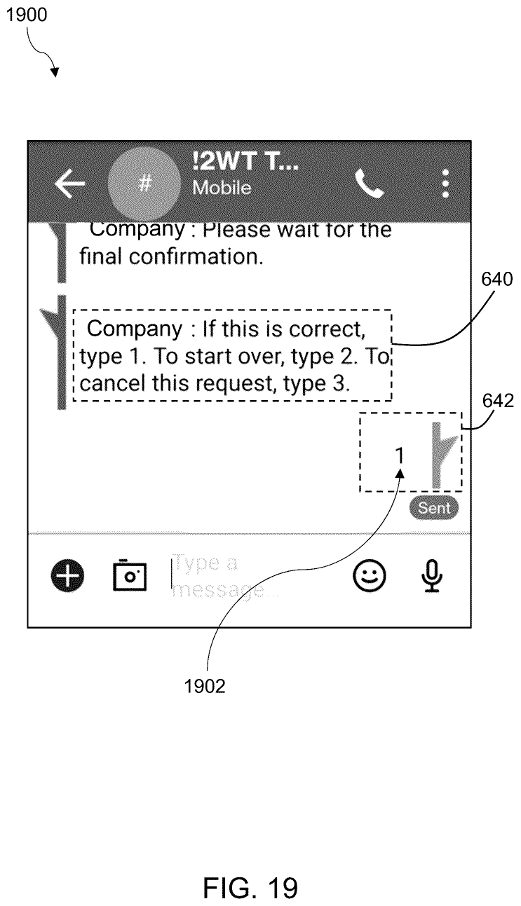

FIG. 19 illustrates an interface 1900 that is a next iteration of the conversation taking place in interface 1800 (shown in FIG. 18) between user 104 (shown in FIG. 1) and chatbot 302 (shown in FIG. 3), and has common features as interface 900 as described above in connection with FIG. 10. Interface 1900 illustrates further exchange of messages between user 104 and chatbot 302, where such messages are representative of blocks 640 and 642 (shown in FIG. 6). A user response digit 1902 may be present in block 642 in response to the message in block 640 regarding entering a digit (e.g., “1,” “2,” or “3”) in connection with the accuracy of the confirmation information. In some embodiments, predictive/common responses 908 (shown in FIG. 9) may be programmed to include quick access icons for common responses used to respond to chatbot 302. For example, predictive/common responses 908 may include a quick access icon for “1” and/or “2” and/or “3”, digits that are commonly entered in response to questions asked by the chatbot 302, such as in connection with blocks 640 and 642. This would further increase the ease of use of messaging system 102 from the perspective of user 104.

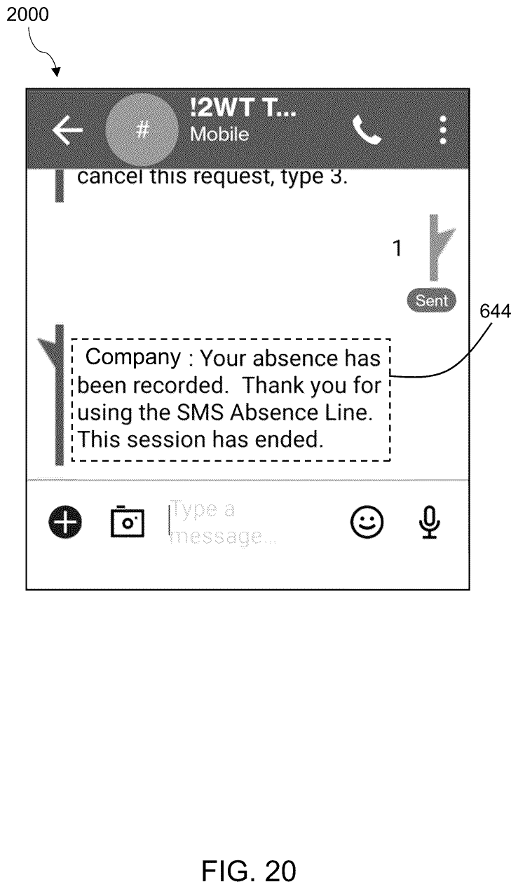

FIG. 20 illustrates an interface 2000 that is a next iteration of the conversation taking place in interface 1900 (shown in FIG. 19) between user 104 (shown in FIG. 1) and chatbot 302 (shown in FIG. 3), and has common features as interface 900 as described above in connection with FIG. 10. Interface 2000 illustrates further exchange of messages between user 104 and chatbot 302, where such message is representative of block 644 (shown in FIG. 6). Upon block 644 and the response thereof being sent, a flag (such as update flag 512 shown in FIG. 5) or other system function may be triggered to start propagation of the absence information throughout ARM system 100. For example, block 644 may trigger compute service 114 to run code (such as update routine 514 shown in FIG. 5) that starts the process of updating workflow management service 120 and email service 122 with the absence information and the sending of automatic updates 154 that are output from services 120 and 122. This may include a script that (i) performs any necessary format conversions of the absence information acquired by chatbot 302 to file formats required by services 120 and 122, (ii) provides services 120 and 122 with the respective file formats, (iii) causes services 120 and 122 to update based on the file formats, and (iv) causes services 120 and 122 to issue automatic updates 154 reflective of the updates.

### Exemplary Computer System

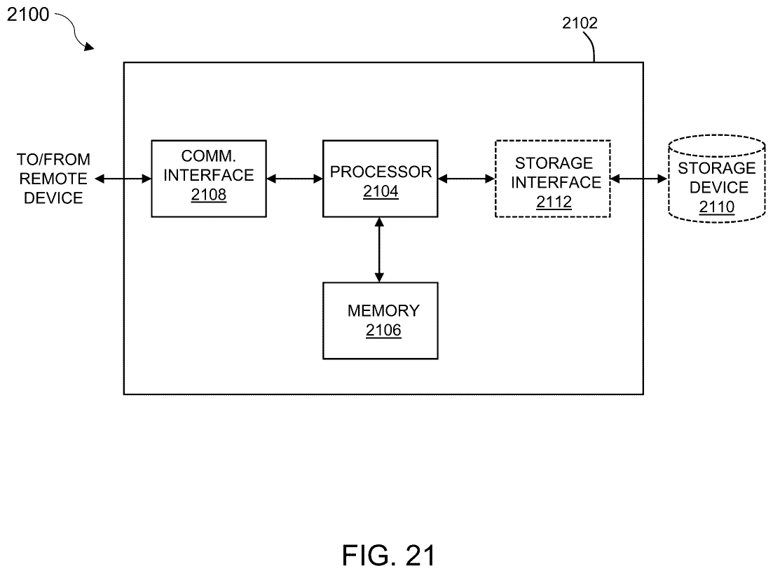

FIG. 21 illustrates block diagrams of an embodiment of a computer system or cloud server in which the present absence reporting processes may be implemented. It should be appreciated that FIG. 21 provides only an illustration of one implementation and does not imply any limitations with regards to the environments in which different embodiments may be implemented. Many modifications to the depicted environments may be made based on design and implementation requirements.

FIG. 21 illustrates an exemplary configuration 2100 of a data processing system 2102 that is representative of any electronic device capable of executing machine-readable program instructions. Examples of such electronic devices include computing systems, environments, and/or configurations that may be represented by data processing system 2102 and include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. For example, any of the servers described herein (e.g., servers 138, 140, 142, 144, 146, and/or 148) may be configured as a data processing system 2102. Backend computing system 110, messaging system 102, and any sub-systems thereof or other computing systems or devices associated therewith may also be configured as a data processing system 2102.

Data processing system 2102 may include a processor 2104 for executing instructions. Instructions may be stored in a memory area 2106. Processor 2104 may include one or more processing units (e.g., in a multi-core configuration). Processor 2104 may be operatively coupled to a communication interface 2108 such that data processing system 2102 is capable of communicating with a remote computing device. For example, data processing system 2102 may receive messages and/or events from outside systems, such as through the input receiver 208 (shown in FIG. 2) via the Internet and/or over locally networked computers and/or cellular network.

Processor 2104 may also be operatively coupled to a storage device 2110 (e.g., which may be implemented as any of databases 212, 214, 216, 224, 226, 228, 234, 236, all shown in FIG. 2, database 308 shown in FIG. 3, and/or database 420 shown in FIG. 4). Storage device 2110 may be any computer-operated hardware suitable for storing and/or retrieving data. In some embodiments, storage device 2110 may be external to data processing system 2102 and may be accessed by a plurality of data processing systems 2102. For example, storage device 2110 may include a storage area network (SAN), a network attached storage (NAS) system, and/or multiple storage units such as hard disks and/or solid-state disks in a redundant array of inexpensive disks (RAID) configuration. In other embodiments, storage device 2110 may be integrated in data processing system 2102. For example, data processing system 2102 may include one or more hard disk drives as storage device 2110. A set of company records utilized in conjunction with ARM system 100 may be stored in a storage device 2110 within ARM system 100, and/or stored across various databases such as user database 214 and absence database 236.

In some embodiments, processor 2104 may be operatively coupled to storage device 2110 via a storage interface 2112. Storage interface 2112 may be any component capable of providing processor 2104 with access to storage device 2110. Storage interface 2112 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 2104 with access to storage device 2110.

### Exemplary User Terminal

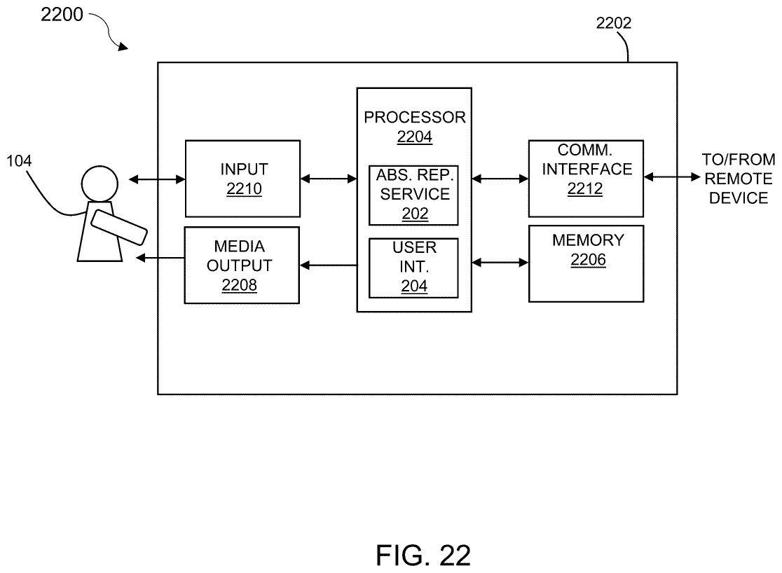

FIG. 22 illustrates a block diagram of an embodiment of a user terminal in which the present absence reporting processes may be implemented. It should be appreciated that FIG. 22 provides only an illustration of one implementation and does not imply any limitations with regards to the environments in which different embodiments may be implemented. Many modifications to the depicted environments may be made based on design and implementation requirements.

FIG. 22 depicts an exemplary configuration 2200 of a user terminal 2202 and which may be configured as a user computer device, in accordance with one embodiment of the present disclosure. In the exemplary embodiment, user terminal 2202 may be similar to, or the same as, user terminal 106 (shown in FIG. 1). User terminal 2202 may be operated by a user 104.

User terminal 2202 may include a processor 2204 for executing instructions. In some embodiments, executable instructions may be stored in a memory area 2206. Processor 2204 may include one or more processing units (e.g., in a multi-core configuration). Memory area 2206 may be any device allowing information such as executable instructions and/or transaction data to be stored and retrieved. Memory area 2206 may include one or more computer readable media.

User terminal 2202 may also include at least one media output component 2208 for presenting information to user 104. Media output component 2208 may be any component capable of conveying information to user 104. In some embodiments, media output component 2208 may include an output adapter (not shown) such as a video adapter and/or an audio adapter. An output adapter may be operatively coupled to processor 2204 and operatively couplable to an output device such as a display device (e.g., a cathode ray tube (CRT), liquid crystal display (LCD), light emitting diode (LED) display (including OLED), or “electronic ink” display) or an audio output device (e.g., a speaker or headphones).

In some embodiments, media output component 2208 may be configured to present a graphical user interface (e.g., a web browser and/or a client application) to user 104. A graphical user interface may include, for example, an interface for viewing instructions or user prompts. This may include any of interfaces 700-2000 as shown in FIGS. 7-20, including any UI components thereof such as the icons of text messaging application 702 and absence reporting application 802, and elements 902, 904, 906, 908, 910, 912 (shown in FIGS. 9) and 1002 and 1004 (shown in FIG. 10) (which may collectively be referred to as UI elements). In some embodiments, user terminal 2202 may include an input device 2210 for receiving input from user 104. User 104 may use input device 2210 to, without limitation, provide information either through speech or typing.

Input device 2210 may include, for example, a keyboard (e.g., physical or digital), a pointing device, a mouse, a stylus, a touch sensitive panel (e.g., a touch pad or a touch screen), a gyroscope, an accelerometer, a position detector, a biometric input device, and/or an audio input device such as a microphone. A single component such as a touch screen may function as both an output device of media output component 2208 and input device 2210.

User terminal 2202 may also include a communication interface 2212 communicatively coupled to a remote device such as backend computing system 110 (shown in FIG. 1). Communication interface 2212 may include, for example, a wired or wireless network adapter and/or a wireless data transceiver for use with a mobile telecommunications network.

Stored in memory area 2206 are, for example, computer readable instructions for providing a user interface to user 104 via media output component 2208 and, optionally, receiving and processing input from input device 2210. A user interface may include, among other possibilities, a web browser and/or a client application. Web browsers enable users, such as user 104, to display and interact with media and other information typically embedded on a web page or a website from user terminal 106. A client application may allow user 104 to interact with, for example, user terminal 106. For example, instructions may be stored by a cloud service, and the output of the execution of the instructions sent to the media output component 2208.

User 104 may enter text into absence reporting service 202 via input device 2210, which may be configured as a software-based, on-screen keyboard (not shown) provided by the OS of the display of user terminal 106. Absence reporting service 202 and user interface 204 may be integrated in processor 2204.

### Exemplary Computer-Implemented Method

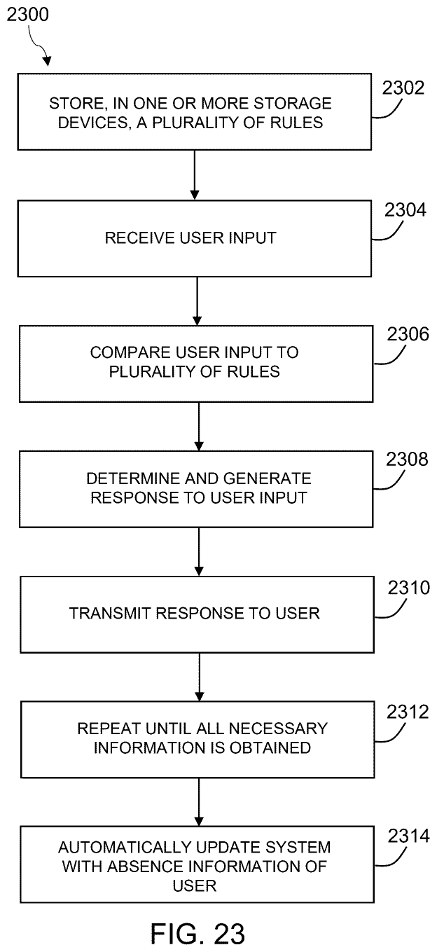

FIG. 23 illustrates a flow chart of an exemplary computer-implemented method 2300 implemented by the ARM system 100 (shown in FIG. 1). In the exemplary embodiment, method 2300 may be implemented by the ARM system 100.

Method 2300 may include storing 2302 a plurality of rules for receiving messages and determining, generating, and transmitting responses to messages. This may include rules stored in various storage devices such as databases 216 and 228 (each shown in FIG. 1) and model rules database 308 (shown in FIG. 3) and as described herein. In some embodiments, the plurality of rules is stored in one or more of the memory area 2106 or the storage device 2110 (both shown in FIG. 21).

Method 2300 may include receiving 2304 a user input (such as input 206 shown in FIG. 2) such as a message from a user when the user uses an absence reporting service as described herein. Absence reporting service may include a chatbot-based text messaging interface that the user can enter text into, such as shown in FIGS. 9-20.

Method 2300 may include comparing 2306 received user inputs to the plurality of rules. The comparison may include comparison (e.g., by comparison module 210 shown in FIG. 2) of information parsed from input 206 to rules and other associated information from, but not limited to, databases 212, 214, 216, 224, 226, 228, 234, 234 (all shown in FIG. 1), database 308 in FIG. 3, and database 420 in FIG. 4, and as described herein.

Method 2300 may include determining and generating 2308 a response to a user input such as input 206 (shown in FIG. 2). This determination and generation may be based on the result of the comparison at 2306, as implemented, for example, by comparison module 210, response generator 220 and response database 224 in conjunction with response rules database 228 (each shown in FIG. 2) and as described herein.

Method 2300 may include transmitting 2310 a response to user 104. This may include transmitting a response as implemented, for example, by response transmitter 222 and transmission database 226 (each shown in FIG. 2) and as described herein.

Method 2300 may include repeating 2312 steps 2302 to 2310 until all required information from user 104 about an absence of user 104 is obtained, as implemented, for example, by loop 510 (shown in FIG. 5) and as described herein.

Method 2300 may include updating 2314 the ARM system 100 with the absence information obtained from steps 2302 to 2312, as implemented, for example at block 514 (shown in FIG. 5) and by integration module 150 and integration rules database 238 for pushing updates to workflow management service 120 and email service 122 and as described herein.

### Exemplary Automatic Update Method

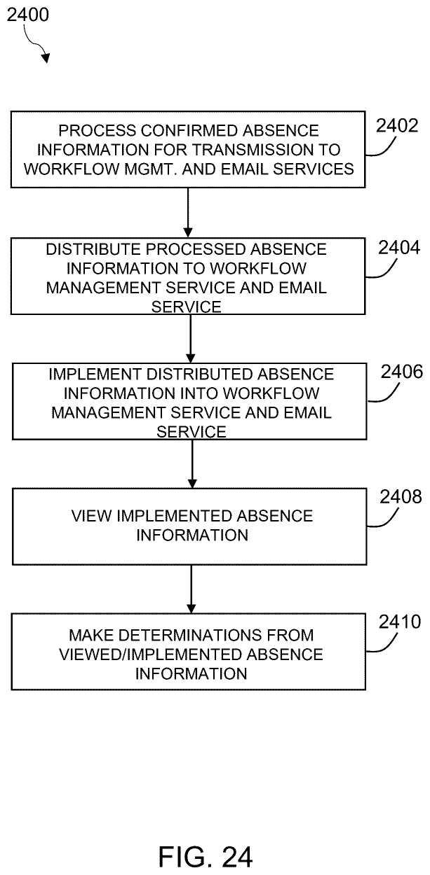

FIG. 24 illustrates a flow chart of an exemplary computer-implemented automatic update method 2400 implemented by the ARM system 100 (shown in FIG. 1). In the exemplary embodiment, method 2400 may be implemented by the ARM system 100 (shown in FIG. 1).

Method 2400 may include processing 2402 the confirmed absence information resulting, for example, from the conversation between user 104 and chatbot 302 for dissemination in the workflow module 132 for updating workflow aspects of the company using ARM system 100. This processing 2402 may include converting the absence information to a file format or other digital form factor or code that is able to be processed by each of workflow management service 120 and email service 122 according to their respective operational parameters and/or requirements, as described herein. For example, the absence information may be populated in a first dedicated file format for workflow management service 120 and a second (e.g., different) dedicated file format for email service 122 so that each of workflow management service 120 and email service 122 can be updated with the absence information accordingly. This processing 2402 may be performed in conjunction with integration module 150 and rules in integration rules database 238 as described herein.

Method 2400 may include distributing 2404 the absence information processed at 2402 to each of workflow management service 120 and email service 122. In some embodiments, this includes output 232 (shown in FIG. 2) including absence data that has been processed according to the operational needs of each of workflow management service 120 and email service 122, so that each workflow management service 120 and email service 122 can respectively intake and implement the absence information.

Method 2400 may include automatically implementing 2406 the absence data into each of workflow management service 120 and email service 122. This may be performed in accordance with integration module 150 (shown in FIG. 1) and rules in integration rules database 238 (shown in FIG. 2).

Method 2400 may include viewing 2408 of the information that has been updated in each of workflow management service 120 and email service 122. For example, a manager or supervisor such as a line of business leader (e.g., a first line leader) of the company may periodically check both scheduling information of workflow management service 120 and email mailboxes and/or calendars within email service 122 that they are in charge of monitoring to stay apprised of the latest workflow status for employees they are responsible for, and to make any necessary staffing changes. Additionally, or alternatively, other team members of the business unit, or members of HR, could monitor the automatic updates 154 to assist with adjusting schedules and/or staffing based on absences.

Method 2400 may include making 2410 determinations based on the viewed absence information. For example, a manager or supervisor of the company may adjust other employees' schedules based on the latest workflow status they viewed in either or both of workflow management service 120 and email service 122. Alternatively, making 2410 determinations could be an automatic process performed by ARM system 100, such as described herein in connection with automatic updates 154.

### Artificial Intelligence and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as text, voice, image, mobile device, and/or telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing-either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

### Additional Considerations

Described herein are computer systems such as the intelligent message routing computer devices and related computer systems. As described herein, all such computer systems include a processor and a memory. However, any processor in a computer device referred to herein can also refer to one or more processors wherein the processor can be in one computing device or a plurality of computing devices acting in parallel. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (e.g., hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM@ DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California). The databases described herein may be located within and/or operatively connected to any part of any system described herein, and such location is not limited by what is shown in the figures.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some examples, the system includes multiple components distributed among a plurality of computer devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present examples can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The systems and processes are not limited to the specific examples described herein. In addition, components of each system and each process can be practiced independent and separate from other components and processes described herein. Each component and process also can be used in combination with other assembly packages and processes.

The patent claims at the end of this document are not intended to be construed under 35 U.S.C. § 112(f) unless traditional means-plus-function language is expressly recited, such as “means for” or “step for” language being expressly recited in the claim(s).

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An absence reporting and management computer system for automated reporting and management of absence notifications, the computer system comprising:
at least one processor;
at least one memory device; and
a plurality of program instructions stored on the at least one memory device for execution by the at least one processor, when executed by the at least one processor, the plurality of program instructions cause the at least one processor to:
receive, via a frontend absence reporting interface executed on a user device associated with a user, an absence notification regarding an absence of the user;
activate, based upon the received absence notification, an electronic absence reporting session, the electronic absence reporting session including entry of one or more text-based messages by the user via the frontend absence reporting interface executed on the user device;
electronically parse, via a natural language processing (NLP) tool associated with the frontend absence reporting interface, each of the one or more text-based messages to determine an intent of the one or more text-based messages;
automatically generate, via the NLP tool, one or more responses to the one or more text-based messages based upon the determined intent and by electronically applying a plurality of absence reporting rules stored in the at least one memory device;
electronically extract absence data from the one or more text-based messages and the one or more responses, the extracted absence data being configurable for use with a plurality of absence reporting services associated with a backend integration module;
generate a backend update flag corresponding to the extracted absence data;
execute, based upon the backend update flag, a backend update routine causing the extracted absence data to be processed by the backend integration module; and
distribute the processed absence data to each of the plurality of absence reporting services.

2. The computer system of claim 1, wherein the plurality of program instructions further cause the at least one processor to:
using the processed absence data, update workflow information within each of the plurality of absence reporting services that relates to the user based upon user absence parameters associated with the absence data, wherein the updated workflow information is usable by the plurality of absence reporting services to automatically make adjustments to the plurality of absence reporting services to reflect the absence of the user.

3. The computer system of claim 2, wherein the plurality of absence reporting services includes a scheduling service and a communication service, and the user absence parameters include scheduling integration parameters and email integration parameters.

4. The computer system of claim 3, wherein the distribution of the processed absence data to each of the scheduling service and the communication service includes the plurality of program instructions further causing the at least one processor to:
cause, in association with the backend update routine, automatic transmission of the processed absence data to:
(i) the scheduling service, to cause the scheduling service to automatically update one or more schedules associated with the user based upon the scheduling integration parameters associated with the absence data as part of the updated workflow information of the scheduling service, the one or more updated schedules being updated to reflect the absence of the user; and
(ii) the communication service, to cause the communication service to automatically send one or more emails to one or more recipients associated with the user based upon the email integration parameters associated with the absence data as part of the updated workflow information of the communication service, the one or more emails being configured to indicate the absence of the user to the one or more recipients.

5. The computer system of claim 3, wherein the plurality of program instructions further cause the at least one processor to, as part of the extracted absence data being processed, convert the extracted absence data to a first format compatible with the scheduling service for updating the workflow information of the scheduling service with the converted absence data in the first format and a second format compatible with the communication service for updating the workflow information of the communication service with the converted absence data in the second format.

6. The computer system of claim 1, wherein the at least one memory device has stored therein an artificial intelligence (AI) chatbot that is associated with the NLP tool, and the plurality of program instructions further cause the at least one processor to:
detect, via the NLP tool, a trigger word associated with the absence notification;
activate the electronic absence reporting session based upon the detection of the trigger word; and
conduct, as part of the electronic absence reporting session, a conversation with the user via the AI chatbot within the frontend absence reporting interface, wherein exchanges between the user and the AI chatbot during the conversation include the one or more text-based messages and the one or more responses.

7. The computer system of claim 1, wherein the user is an employee of an employer that provides the absence reporting and management computer system and the NLP tool is executed in association with a machine learning model trained on at least one of (i) historical absence data and (ii) historical absence hotline scripts.

8. The computer system of claim 1, wherein at least one of the one or more text-based messages and the one or more responses includes data corresponding to one or more of (i) an alias that is associated with the user within a set of records of the employer, (ii) a line of business that is associated with the user within the set of records of the employer, (iii) a time zone associated with the user, (iv) a reason for the absence of the user, and (v) a duration of the absence of the user.

9. The computer system of claim 1, further comprising at least one database, the at least one database having stored therein alias information and name information of the user, the one or more text-based messages including an alias message including an alias that is associated with the user, wherein the plurality of program instructions further cause the at least one processor to:
compare, based upon a plurality of alias matching rules stored in the at least one database, the alias included in the alias message to the alias information stored in the at least one database;
determine, based upon the plurality of alias matching rules, if an alias match exists between the alias included in the alias message and a user alias included in the alias information; and
if an alias match is determined to exist, display a user name associated with the user alias to the user via the frontend absence reporting interface on the user device, the user name having been associated with the user alias in the name information in the at least one database.

10. The computer system of claim 9, wherein the at least one database has stored therein line of business information, the one or more text-based messages including a line of business message including a line of business pin number associated with a line of business that is associated with the user, and the plurality of program instructions further cause the at least one processor to:
compare, based upon a plurality of line of business matching rules stored in the at least one database, the line of business pin number included in the line of business message to the line of business information stored in the at least one database;
determine, based upon the plurality of line of business matching rules, if a line of business match exists between the line of business pin number included in the line of business message and a line of business pin number included in the line of business information; and
if a line of business match is determined to exist, display a line of business name associated with the line of business pin number included in the line of business information to the user via the frontend absence reporting interface on the user device, the line of business name having been associated with the line of business pin number included in the line of business information in the at least one database.

11. The computer system of claim 1, wherein (i) the one or more text-based messages are text messages entered by the user on the user device into a text entry interface included as part of the frontend absence reporting interface, and (ii) the absence notification includes a keyword entered by the user into the text entry interface that triggers a start of the electronic absence reporting session.

12. A computer-implemented method for automated reporting and management of absence notifications, the computer-implemented method comprising:
receiving, via a frontend absence reporting interface executed on a user device associated with a user and by one or more processors, an absence notification regarding an absence of the user;
activating, based upon the received absence notification, an electronic absence reporting session, the electronic absence reporting session including entry of one or more text-based messages by the user via the frontend absence reporting interface executed on the user device;
electronically parsing, via a natural language processing (NLP) tool associated with the frontend absence reporting interface and by the one or more processors, each of the one or more text-based messages to determine an intent of the one or more text-based messages;
automatically, via the NLP tool and by the one or more processors, generating one or more responses to the one or more text-based messages based upon the determined intent and by electronically applying a plurality of absence reporting rules stored in at least one memory device associated with the one or more processors;
electronically extracting, by the one or more processors, absence data from the one or more text-based messages and the one or more responses, the extracted absence data being configurable for use with a plurality of absence reporting services associated with a backend integration module;
generating a backend update flag corresponding to the extracted absence data;
executing, based upon the backend update flag and by the one or more processors, a backend update routine causing the extracted absence data to be processed by the backend integration module; and
distributing the processed absence data to each of the plurality of absence reporting services.

13. The computer-implemented method of claim 12, further comprising:
using the processed absence data, updating, by the one or more processors, workflow information within each of the plurality of absence reporting services that relates to the user based upon user absence parameters associated with the absence data, wherein the updated workflow information is usable by the plurality of absence reporting services to automatically make adjustments to the plurality of absence reporting services to reflect the absence of the user.

14. The computer-implemented method of claim 13, wherein the plurality of absence reporting services includes a scheduling service and a communication service, and the user absence parameters include scheduling integration parameters and email integration parameters.

15. The computer-implemented method of claim 14, wherein the distributing of the processed absence data to each of the scheduling service and the communication service includes:
causing, in association with the backend update routine and by the one or more processors, automatic transmission of the processed absence data to:
(i) the scheduling service, to cause the scheduling service to automatically update one or more schedules associated with the user based upon the scheduling integration parameters associated with the absence data as part of the updated workflow information of the scheduling service, the one or more updated schedules being updated to reflect the absence of the user; and
(ii) the communication service, to cause the communication service to automatically send one or more emails to one or more recipients associated with the user based upon the email integration parameters associated with the absence data as part of the updated workflow information of the communication service, the one or more emails being configured to indicate the absence of the user to the one or more recipients.

16. The computer-implemented method of claim 14, further comprising converting, as part of the extracted absence data being processed and by the one or more processors, the extracted absence data to a first format compatible with the scheduling service for updating the workflow information of the scheduling service with the converted absence data in the first format and a second format compatible with the communication service for updating the workflow information of the communication service with the converted absence data in the second format.

17. One or more non-transitory computer-readable storage media for automated reporting and management of absence notifications, the one or more non-transitory computer-readable storage media comprising a plurality of instructions stored thereon that, in response to being executed, cause an absence reporting and management computer system to:
receive, via a frontend absence reporting interface executed on a user device associated with a user, an absence notification regarding an absence of the user
activate, based upon the received absence notification, an electronic absence reporting session, the electronic absence reporting session including entry of one or more text-based messages by the user via the frontend absence reporting interface executed on the user device;
electronically parse, via a natural language processing (NLP) tool associated with the frontend absence reporting interface, each of the one or more text-based messages to determine an intent of the one or more text-based messages;
automatically generate, via the NLP tool, one or more responses to the one or more text-based messages based upon the determined intent and by electronically applying a plurality of absence reporting rules stored in the one or more non-transitory computer-readable storage media;
electronically extract absence data from the one or more text-based messages and the one or more responses, the extracted absence data being configurable for use with a plurality of absence reporting services associated with a backend integration module;
generate a backend update flag corresponding to the extracted absence data;
execute, based upon the backend update flag, a backend update routine causing the extracted absence data to be processed by the backend integration module; and
distribute the processed absence data to each of the plurality of absence reporting services.

18. The one or more non-transitory computer-readable storage media of claim 17, wherein the plurality of absence reporting services includes a scheduling service and a communication service.

19. The one or more non-transitory computer-readable storage media of claim 18, wherein the distribution of the processed absence data to each of the scheduling service and the communication service includes the plurality of instructions, in response to being executed, further causing the absence reporting and management computer system to:
cause, in association with the backend update routine, automatic transmission of the processed absence data to:
(i) the scheduling service, to cause the scheduling service to automatically update one or more schedules associated with the user based upon scheduling integration parameters associated with the absence data as part of the updated workflow information of the scheduling service, the one or more updated schedules being updated to reflect the absence of the user; and
(ii) the communication service, to cause the communication service to automatically send one or more emails to one or more recipients associated with the user based upon email integration parameters associated with the absence data as part of the updated workflow information of the communication service, the one or more emails being configured to indicate the absence of the user to the one or more recipients.

20. The one or more non-transitory computer-readable storage media of claim 17, wherein the one or more non-transitory computer-readable storage media of has stored thereon an artificial intelligence (AI) chatbot that is associated with the NLP tool, and the plurality of instructions, in response to being executed, further cause the absence reporting and management computer system to:
detect, via the NLP tool, a trigger word associated with the absence notification;
activate the electronic absence reporting session based upon the detection of the trigger word; and
conduct, as part of the electronic absence reporting session, a conversation with the user via the AI chatbot within the frontend absence reporting interface, wherein exchanges between the user and the AI chatbot during the conversation include the one or more text-based messages and the one or more responses.
